(19) United States
(12) Patent Application Publication
(10) Pub. No.: US 2025/0332837 A1
(43) Pub. Date: Oct. 30, 2025

(54) LIQUID AGITATING APPARATUS

(71) Applicant: CANON KABUSHIKI KAISHA, Tokyo (JP)

(72) Inventors: MASAKAZU NAGASHIMA, Kanagawa (JP); HIROMASA YONEYAMA, Kanagawa (JP); YUJIRO ISHIDA, Tokyo (JP); SHU KURIHARA, Tokyo (JP); KOHEI FUKUI, Tokyo (JP); RYOHEI MARUYAMA, Kanagawa (JP); KENTA IIMURA, Kanagawa (JP)

(21) Appl. No.: 19/185,133

(22) Filed: Apr. 21, 2025

(30) Foreign Application Priority Data
Apr. 26, 2024 (JP) 2024-072926

(51) Int. Cl. B41J 2/17; B41J 2/175; B41J 2/21

(52) U.S. Cl. CPC B41J 2/1707; B41J 2/1721; B41J 2/17513; B41J 2/17523; B41J 2/17553; B41J 2/2117; B41J 2002/17516

(57) ABSTRACT

A liquid agitating apparatus includes a first storing container configured to store a first liquid, a first agitating mechanism configured to agitate the first liquid in the first storing container by causing the first storing container to undergo a first movement, a second storing container configured to store a second liquid different from the first liquid; and a second agitating mechanism configured to agitate the second liquid in the second storing container by causing the second storing container to undergo a second movement different from the first movement.

### BACKGROUND OF THE INVENTION

### Field of the Invention

The present invention relates to liquid agitation technology.

### Description of the Related Art

Liquids containing substances that tend to settle sometimes need to be agitated prior to use in order to disperse precipitates. For example, in a recording apparatus that performs recording by ejecting liquid ink onto a recording medium, when using an ink such as a pigment ink or a metallic ink, the ink sometimes needs to be agitated in order to disperse precipitates. Japanese Patent Laid-Open No. 5-338195 and Japanese Patent No. 6567186 disclose an apparatus that agitates ink by rotating an ink storage portion.

However, there is room for improvement in the structure of conventional liquid agitating apparatuses.

### SUMMARY OF THE INVENTION

The present invention provides a liquid agitating apparatus having a structural characteristic.

According to an aspect of the present invention, there is provided a liquid agitating apparatus comprising: a first storing container configured to store a first liquid; a first agitating mechanism configured to agitate the first liquid in the first storing container by causing the first storing container to undergo a first movement; a second storing container configured to store a second liquid different from the first liquid; and a second agitating mechanism configured to agitate the second liquid in the second storing container by causing the second storing container to undergo a second movement different from the first movement.

Further features of the present invention will become apparent from the following description of exemplary embodiments with reference to the attached drawings.

### BRIEF DESCRIPTION OF THE DRAWINGS

FIG. 1 is a perspective view of a system according to an embodiment of the present invention.

FIG. 2 is a front view of the system of FIG. 1.

FIG. 3 is an illustrative diagram of an internal structure of a liquid ejection apparatus.

FIG. 4 is a front view of a storage portion.

FIG. 5 is a perspective view of a liquid container and a container support unit.

FIG. 6 is an illustrative diagram showing a manner in which the container support unit is mounted to the storage portion.

FIG. 7 is an illustrative diagram of operation of a handle.

FIG. 8 is a perspective view of a liquid agitating apparatus.

FIG. 9 is a perspective view of the liquid agitating apparatus.

FIG. 10 is a front view of a storage space.

FIG. 11 is a diagram showing a stored state of the container support unit.

FIG. 12 is a front view of the liquid agitating apparatus.

FIG. 13 is a perspective view of a rear portion of the liquid agitating apparatus.

FIG. 14 is a diagram showing an example of an agitating operation.

FIG. 15 is an illustrative diagram of a rotation restriction unit.

FIG. 16 is a diagram showing an aspect of rotation restriction.

FIG. 17 is a diagram showing an aspect of rotation restriction.

FIG. 18 is an illustrative diagram of a position detection operation.

FIG. 19 is an illustrative diagram of a flow passage forming member and a valve unit.

FIG. 20 is a diagram showing an example of a change in the posture of the flow passage forming member during rotation.

FIG. 21 is an illustrative diagram of an arrangement of movable and fixed tube fixing members.

FIG. 22 is an illustrative diagram of a holding member.

FIG. 23 is a diagram showing an example of change in tubes and the like during rotation.

FIG. 24 is a block diagram of a control circuit of the system of FIG. 1.

FIG. 25 is an illustrative diagram of an example of control.

FIG. 26 is an illustrative diagram of an example of control.

FIG. 27 is an illustrative diagram of another example.

FIG. 28 is an illustrative diagram of another example.

FIG. 29 is an illustrative diagram of another example.

FIG. 30 is a perspective view of a system according to a third embodiment of the present invention.

FIG. 31 is a front view of the system of FIG. 30.

FIG. 32 is a diagram showing an arrangement of containers in a liquid storage device.

FIG. 33 is a rear view of the liquid storage device.

FIG. 34 is a partially exploded perspective view of the liquid storage device.

FIG. 35 is a perspective view of a container and a support unit.

FIGS. 36A and 36B are illustrative diagrams of operation of a handle and a lock mechanism.

FIGS. 37A to 37C are illustrative diagrams of operation of the lock mechanism.

FIG. 38 is a diagram showing a mounting posture and insertion/removal of the support unit with respect to the storage portion.

FIG. 39 is an illustrative diagram of operation of a pressing unit.

FIG. 40 is an illustrative diagram of operation of the pressing unit.

FIGS. 41A and 41B include illustrative diagrams of a cam.

FIG. 42 is a perspective view of a case with an agitation function and a support unit in a separated state.

FIG. 43 is a perspective view of the case with an agitation function and the support unit in the mounted state.

FIGS. 44A to 44C are illustrative diagrams of an agitating operation.

FIG. 45 is a diagram showing another agitating method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

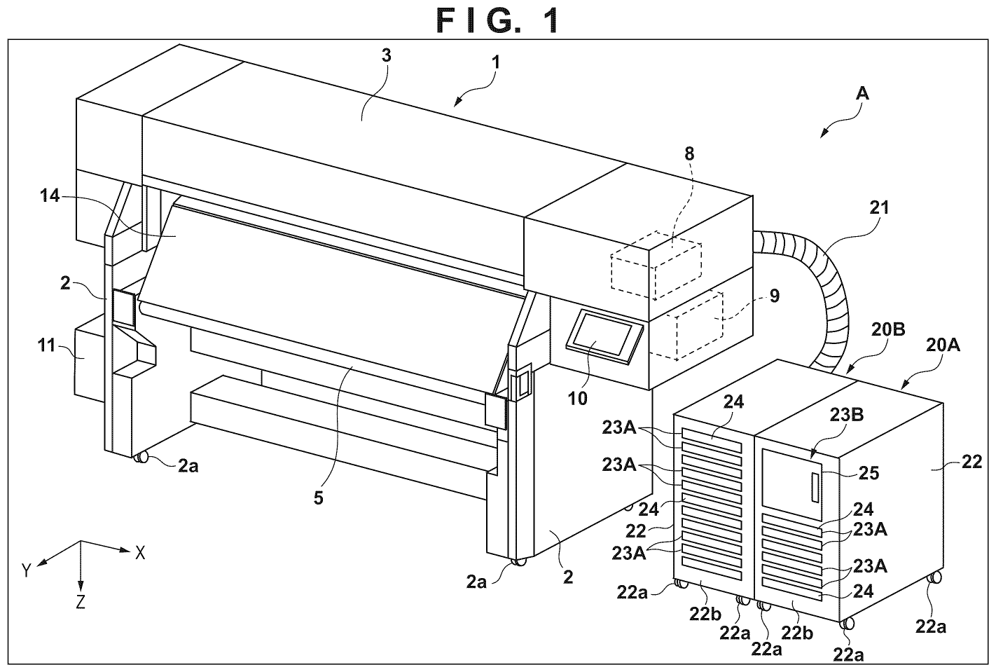

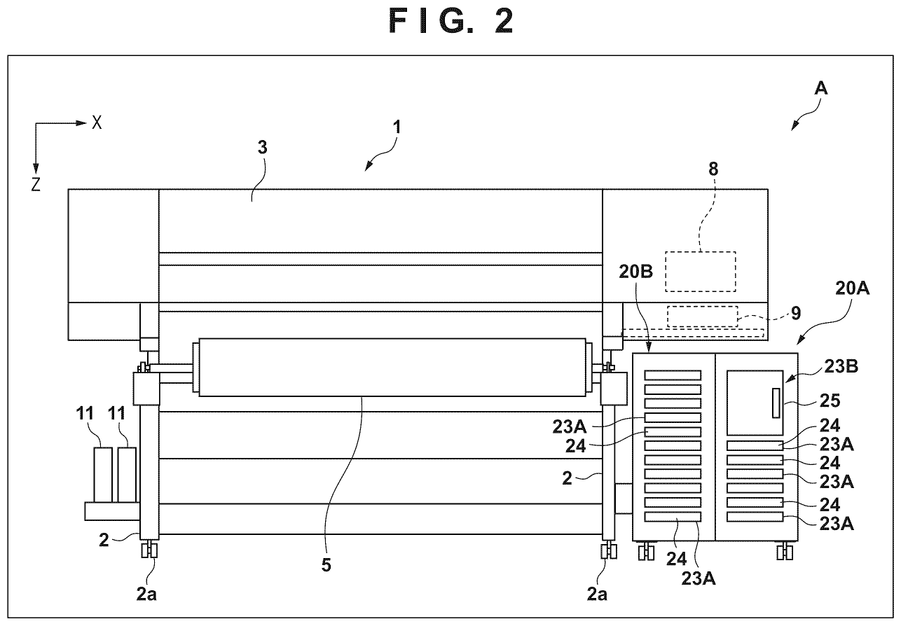

FIG. 1 is a perspective view of a system A according to an embodiment of the present invention, and FIG. 2 is a front view of the system A. In the figures, arrows X, Y, and Z indicate directions that intersect each other, and in the present embodiment, these directions are orthogonal to each other. When the system A is installed on a horizontal surface, the left-right direction is the X direction, the front-rear direction is the Y direction, and the up-down direction is the Z direction. The X direction and the Y direction can also be called lateral directions.

The system A of the present embodiment is a recording system that includes a liquid ejection apparatus 1 and liquid storage devices 20A and 20B, and records an image by ejecting ink onto a recording medium such as paper. In the present embodiment, two liquid storage devices 20A and 20B are provided. The liquid ejection apparatus 1 is arranged side by side with the two liquid storage devices 20A and 20B in the X direction. The liquid that the liquid storage devices 20A and 20B supply to the liquid ejection apparatus 1 is mainly ink, and the liquid ejection apparatus 1 is a recording apparatus that ejects ink onto a recording medium. However, the present invention is not limited to a recording system, and can be applied to various liquid ejection systems intended for ejecting liquid onto a medium.

Also, “recording” includes not only the formation of meaningful information such as characters and figures, but also modification of the medium and the formation of images, designs, patterns, and the like on a recording medium, regardless of whether they are meaningful or not, and regardless of whether or not they are manifested in a way that can be perceived by humans visually. Also, in the present embodiment, the “recording medium” is envisioned to be a sheet of paper, but it may also be cloth, plastic film, or the like.

### Liquid Ejection Apparatus

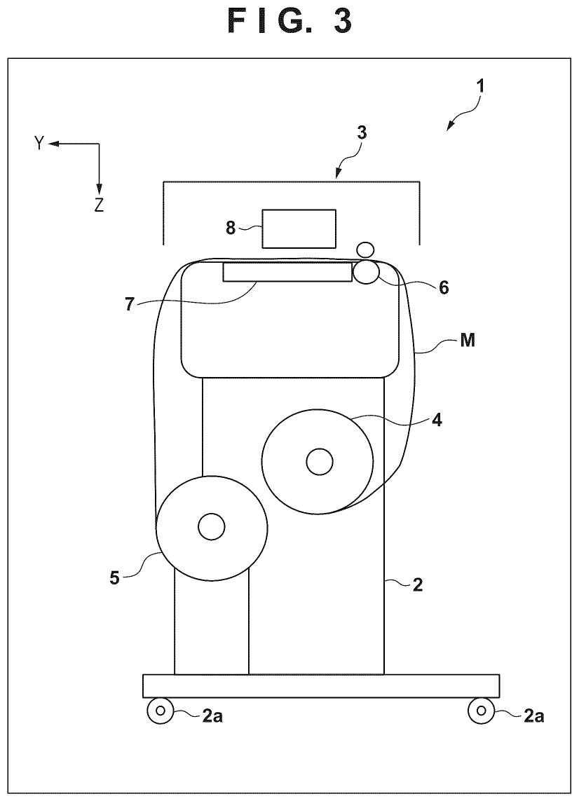

The liquid ejection apparatus 1 will be described below with reference to FIGS. 1 and 2, and additionally FIG. 3. FIG. 3 is an illustrative diagram of the internal structure of the liquid ejection apparatus 1. The liquid ejection apparatus 1 includes a pair of left and right stands 2 and a main body 3 supported on the pair of stands 2. Each of the stands 2 includes casters 2a, and thus the liquid ejection apparatus 1 can be moved relatively easily on the floor (installation surface). A feeding unit 4, a drying unit 14, and a winding unit 5 are arranged below the main body 3. In the present embodiment, the recording medium M is roll paper, and the feeding unit 4 includes a shaft around which the recording medium M is wound. The winding unit 5 includes a shaft for winding up the recording medium M. Although roll paper is given as an example as the recording medium M in the present embodiment, cut paper may also be used.

The main body 3 includes a conveying unit 6. The conveying unit 6 includes a drive roller and a driven roller, and the recording medium M fed from the feeding unit 4 is sandwiched in the nip between these rollers. The recording medium M is conveyed onto a platen 7 by rotation of the drive roller. An ejection head 8 is disposed facing the platen 7. The ejection head 8 is a recording head that ejects ink to form an image. An image is recorded on the recording medium M by ejection of ink from the ejection head 8 onto the recording medium M conveyed onto the platen 7.

The ejection head 8 has ejection energy generating elements, such as electrothermal conversion elements (heaters) or piezoelectric elements, and ejects ink from ejection openings. In the case of using an electrothermal conversion element, heat generated by the element causes the ink to bubble, and the resulting bubbling energy can be used to eject the ink from the ejection opening. The recording method employed by the ejection head 8 may be a serial scan method or a full line method. In the case of the serial scan method, the ejection head 8 is mounted on a carriage and moves back and forth in the X direction. The operation of ejecting ink while moving the ejection head 8 in the X direction is called recording scanning. An image is recorded on the recording medium M by alternately repeating conveyance of the recording medium M and recording scanning of the ejection head 8. In the present embodiment, it is assumed that the serial scan method is adopted. In the case of the full line method, the ejection head 8 is elongated in the X direction and records an image while the recording medium M is conveyed in a continuous manner.

The recording medium M on which an image has been recorded passes through the drying unit 14 and is then wound up by the winding unit 5. The drying unit 14 reduces the amount of the liquid component contained in the ink applied onto the recording medium M by the ejection head 8, and improves the fixation of the ink to the recording medium M. The drying unit 14 has a heat source such as a heater and an air blowing mechanism such as a fan, and dries the recording medium M by blowing hot air onto at least the ink-applied surface of the passing recording medium M. In addition to applying hot air, drying may be performed also using a method of irradiating the surface of the recording medium M with electromagnetic waves (ultraviolet rays, infrared rays, or the like) or a conductive heat transfer method using contact with a heating element. Moreover, the drying unit 14 may be a unit that does not have a heat source and only blows air. The recording medium M on which the image has been recorded is cut by a user with scissors or the like, or is automatically cut by a cutter (not shown).

A recovery unit 9 is disposed in the main body 3. The recovery unit 9 is disposed outside the recording area (outside the ejection area) of the ejection head 8, and performs processing related to recovery and maintenance of the ejection performance of the ejection head 8. Such processing may include, for example, preliminary ejection for ejecting a predetermined amount of ink before/after a recording operation, and processing for suctioning remaining ink or the like from the ejection openings of the ejection head 8. When recovery processing is necessary, the ejection head 8 is moved to a position over the recovery unit 9 as shown in FIG. 2.

An operation panel 10 is provided on the front surface of the main body 3. The operation panel 10 is, for example, a touch panel, and is capable of accepting input of various recording-related settings and displaying the status of a recording job, for example. The liquid ejection apparatus 1 is also provided with a waste liquid cartridge 11. The waste liquid cartridge 11 is disposed below the end of the main body 3 on the side opposite to the liquid storage devices 20A and 20B in the X direction.

Waste liquid (e.g., waste ink) suctioned by the recovery unit 9 flows into the waste liquid cartridge 11 and is collected. The waste liquid cartridge 11 may be disposed in the vicinity of the recovery unit 9. However, in the case of the present embodiment, the waste liquid cartridge 11 is disposed in the empty space below one end of the main body 3, thus reducing the installation surface area required for the liquid ejection apparatus 1.

### Liquid Storage Device

FIGS. 1 and 2 will be referred to below. The liquid storage devices 20A and 20B are devices that store a liquid (e.g., ink) to be ejected from the ejection head 8, and supply the liquid (e.g., ink) to the liquid ejection apparatus 1. The liquid storage devices 20A and 20B include box-shaped main bodies 22 that form a plurality of storage portions 23A and one storage portion 23B. Casters 22a are provided on the bottom surface of main body 22, thereby enabling the liquid storage devices 20A and 20B to be moved relatively easily across the floor (installation surface).

The liquid storage devices 20A and 20B each include a plurality of storage portions 23A arranged side by side in the Z direction. The storage portions 23A are each shaped as a slot formed in a front wall portion 22b of the main body 22. A container support unit 24 can be inserted into and removed from each of the storage portions 23A in the Y direction. A later-described liquid container 200 (hereinafter also simply referred to as the container 200) can be replaceably supported by each of the container support units 24.

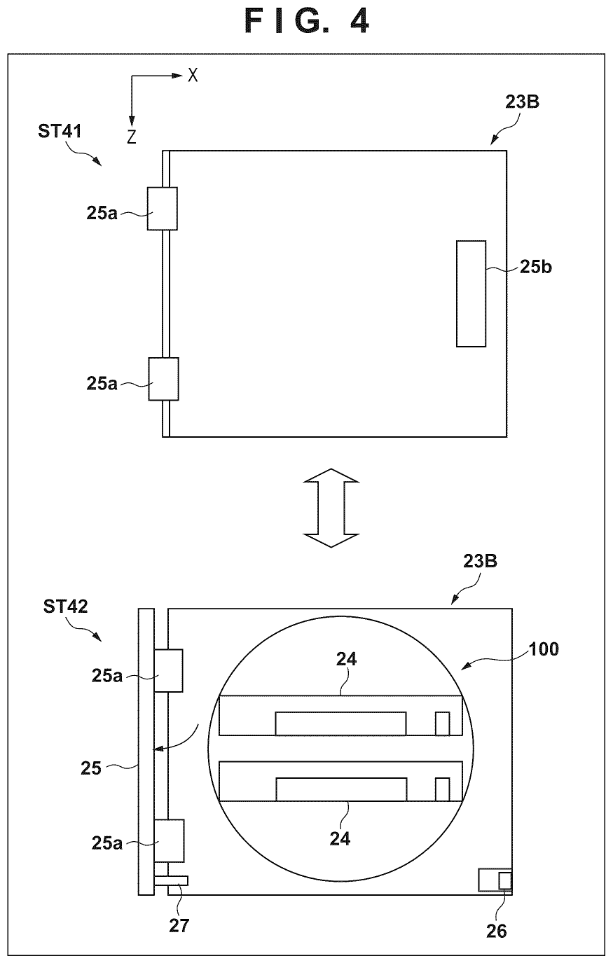

The liquid storage device 20A includes one storage portion 23B. The storage portion 23B has a larger space than the storage portions 23A formed in the front wall portion 22b of the main body 22, and can be opened and closed by an opening/closing member 25 provided in the front wall portion 22b. FIG. 4 is a front view of the storage portion 23B, and in this figure, a state ST41 shows a state in which the opening/closing member 25 is closed, and a state ST42 shows a state in which the opening/closing member 25 is open.

The opening/closing member 25 is a door having one end in the X direction supported by the front wall portion 22b via a plurality of hinges 25a, and a handle 25b that can be gripped by the user is provided at the other end of the door in the X direction. When the user pulls the handle 25b towards them from the state ST41, the opening/closing member 25 rotates about the hinges 25a as the center of rotation as shown in state ST42, and the inside of the storage portion 23B is exposed. Note that although the opening/closing member 25 is a rotating type of member in the present embodiment, it may be a sliding type of member.

The main body 22 includes a sensor 26 for detecting the open/closed state of the opening/closing member 25. The sensor 26 detects a detection piece 27 provided on the opening/closing member 25. The sensor 26 is, for example, an optical sensor, and is disposed so as to detect the detection piece 27 when the opening/closing member 25 is in the closed state, but not to detect the detection piece 27 when the opening/closing member 25 is in the open state.

A liquid agitating apparatus 100 is provided in the storage portion 23B. A plurality of the container support units 24 can be inserted into and removed from the liquid agitating apparatus 100 in the Y direction. In the present embodiment, two container support units 24 can be mounted to the liquid agitating apparatus 100. The liquid agitating apparatus 100 has a function of agitating the liquid in the containers 200 supported by the container support units 24. The liquid agitating apparatus 100 will be described in detail later. Note that although the same type of container support unit 24 is used in the storage portion 23A and the storage portion 23B in the present embodiment, different container support units may be used.

The storage portions 23A and 23B each include a tube for connecting the container 200 to the liquid ejection apparatus 1. The tubes are connected to the liquid ejection apparatus 1 through a single hose 21 in which all of the tubes are contained. The ink in the containers 200 is supplied to the ejection head 8 via the tubes.

Due to the system A of the present embodiment including the two liquid storage devices 20A and 20B, a larger amount of ink can be used. When the number of colors of ink is increased to improve image quality, or the number of containers of ink of the same color is increased to improve productivity, it is advantageous to provide a plurality of liquid storage devices 20A and 20B in this manner.

### Liquid Container and Container Support Unit

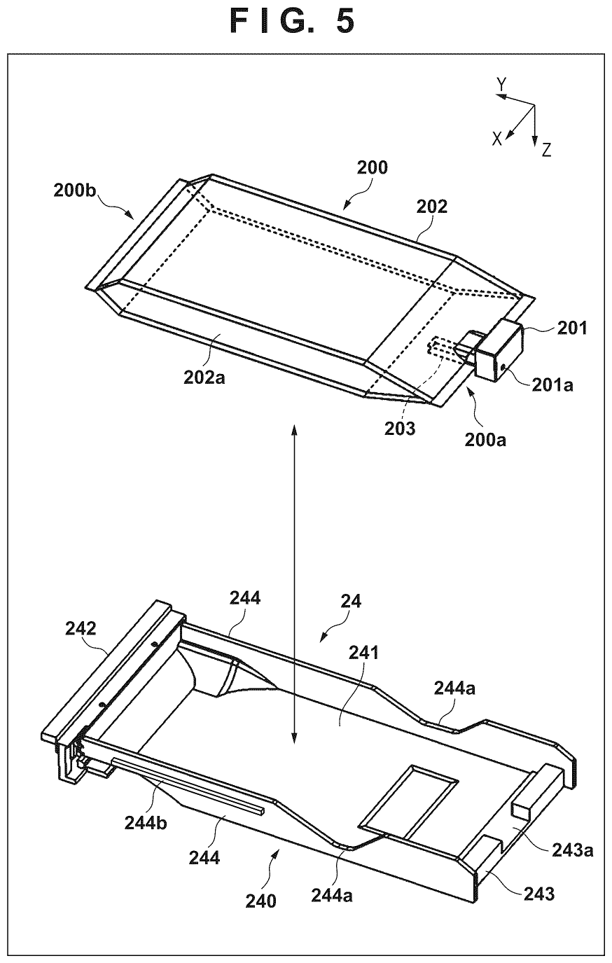

FIG. 5 is a perspective view of the container 200 and the container support unit 24. The container 200 has a bag 202 formed from a flexible material. The two sides of the bag 202 are provided with gusset portions 202a folded inward to increase the amount of liquid that can be contained. The bag 202 is formed into a bag shape by welding together the sheets constituting the top and bottom surfaces and the sheets forming the gusset portions 202a, thereby forming a flexible tank for storing a liquid. As the amount of liquid inside increases, the gusset portions 202a expand, and as the amount of liquid inside decreases, the gusset portions 202a fold inward, and in this way, the shape of the bag 202 changes according to the amount of liquid contained therein. The material constituting the bag 202 is, for example, a material having a multi-layer structure such as PET. If there is concern that the liquid inside may react with air and solidify, or that the concentration or remaining amount may change due to evaporation, a layer material containing an aluminum layer can be advantageously used as the material for the bag 202.

The container 200 has one end portion 200a and another end portion 200b in the longitudinal direction. When mounted to the liquid storage device 20A or 20B, the end portion 200a is located on the rear side of the liquid storage device 20A or 20B, and the end portion 200b is located on the front side. An outlet member 201 is provided at the end portion 200a. The outlet member 201 has a supply port 201a that is in communication with an intake port 203 inside the bag 202. The liquid contained in the bag 202 flows out through the intake port 203 and the supply port 201a. A spring-loaded supply port opening/closing valve for opening and closing the supply port 201a is provided inside the outlet member 201. The supply port 201a is normally kept in the closed state by the supply port opening/closing valve.

The side of the container 200 on which the outlet member 201 is provided has a length of, for example, about 180 mm, and the sides orthogonal thereto (side surfaces) have a length of, for example, about 400 mm. The container 200 contains, for example, about 1.5 L of liquid. Note that the side on which the outlet member 201 is located may be the long side instead of the short side. Additionally, the bag 202 may be square rather than rectangular in a plan view.

The container support unit 24 has a support portion 240 for supporting the container 200, and has the overall form of a tray on which the container 200 is placed in a lying posture. The support portion 240 has a placement surface 241 on which the container 200 is placed, and the four sides of the placement surface 241 are defined by left and right side plates 244, a front end portion 242, and a rear end portion 243. The side plates 244 are each provided with a notch 244a. The rear end portion 243 is provided with a recessed portion 243a in which the outlet member 201 is disposed. The side plates 244 each include a rib 244b that extends in the Y direction.

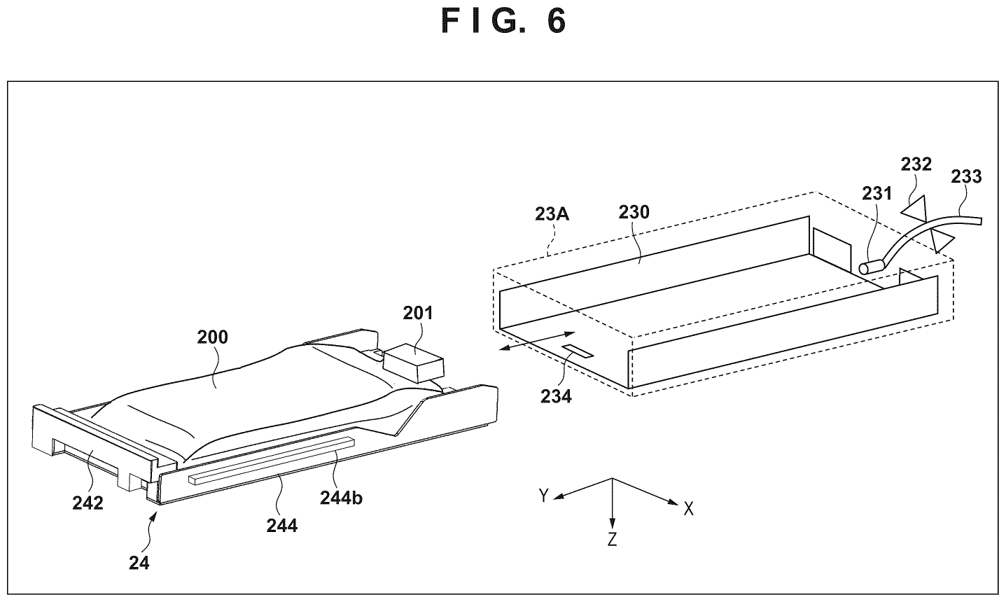

FIG. 6 will be referred to below. FIG. 6 is an illustrative diagram showing a manner in which the container support unit 24 is mounted to the storage portion 23A. Note that although the manner in which the container support unit 24 is mounted to the storage portion 23A will be described here, the manner in which the container support unit 24 is mounted to the liquid agitating apparatus 100 in the storage portion 23B is substantially the same.

The storage portion 23A is provided with a case 230 for receiving the container support unit 24. The container support unit 24 is displaceable in the Y direction between a storage position at which the container 200 is stored in the main body 22 and a removed position at which the container 200 is exposed to the outside of the main body 22. FIG. 6 shows the container support unit 24 in the removed position. In the removed position, the container 200 can be replaced. In the storage position, the container 200 is mounted to the case 230.

Note that in the present embodiment, at the removed position, the container support unit 24 is separated from the storage portion 23A. However, the removed position may be a position at which an end of the container support unit 24 is held in the storage portion 23A, and may be any position at which the container 200 can be replaced in the container support unit 24.

A needle member 231 that can be inserted into the supply port 201a is provided on the rear side of the case 230 in the Y direction. The needle member 231 is provided for each of the storage portions 23A. When the container support unit 24 is located at the storage position, the needle member 231 is inserted into and connected to the supply port 201a. As a result, the supply port opening/closing valve inside the outlet member 201 is set to the open state by the insertion of the needle member 231. The needle member 231 is connected to a tube 233. The needle member 231 and the tube 233 form a flow passage through which the liquid contained in the bag 202 flows out to the liquid ejection apparatus 1, which is the supply destination. An electrically operated flow passage valve 232 is provided at an intermediate position in the tube 233. The tube 233 can be closed and opened by opening and closing the flow passage valve 232.

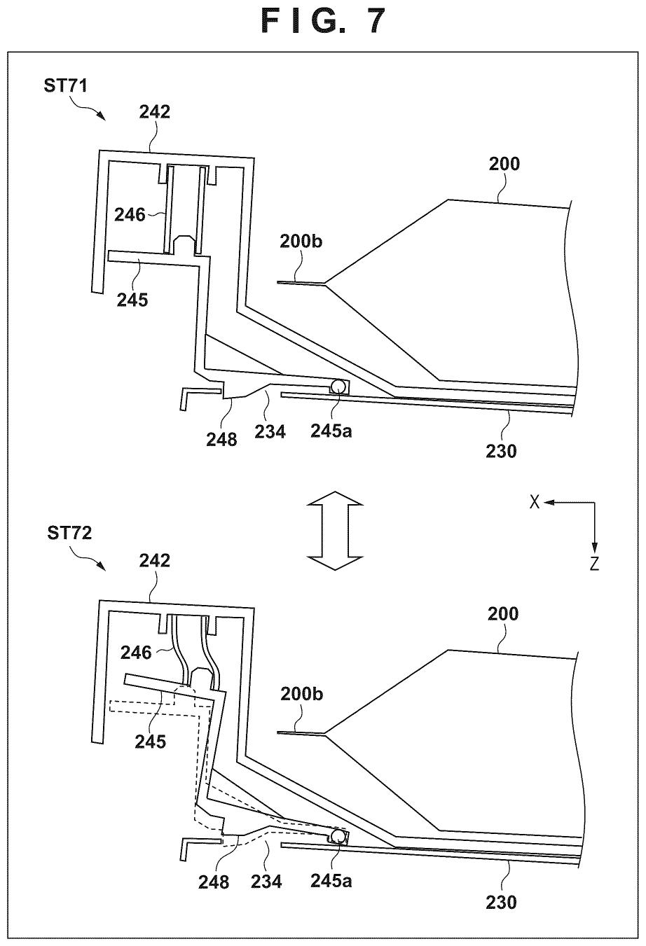

A mechanism for holding the container support unit 24 in the storage position will be described below with reference to FIG. 7. FIG. 7 is an illustrative diagram of operation of a handle provided on the container support unit 24. A state ST71 in FIG. 7 indicates a held state, and a state ST72 indicates a released state.

A handle 245 that is rotatable about a shaft 245a extending in the X direction is provided at the front end portion 242 of the container support unit 24, and a user can operate the handle 245. The handle 245 also serves as an operation handle for an engagement portion 248. The handle 245 is provided with the engagement portion 248, and the bottom of the case 230 is provided with an engagement portion 234 that engages with the engagement portion 248.

In the present embodiment, the engagement portion 248 is a protrusion, and the engagement portion 234 is a recess or a hole into which the engagement portion 248 is inserted. Engagement between the engagement portion 248 and the engagement portion 234 can prevent the container support unit 24 from coming out of the storage portion 23A even if vibration occurs due to, for example, movement of the liquid storage device 20A.

The handle 245 is constantly biased by an elastic member 246 toward an engaged position at which the engagement portion 248 and the engagement portion 234 are engaged with each other (the position in the state ST71 in FIG. 7). The elastic member 246 is, for example, a coil spring. When the user grabs the handle 245 and rotates the handle 245, the engagement portion 248 and the engagement portion 234 become disengaged as shown in the state ST72, and the container support unit 24 inside the storage portion 23A can be removed from the storage portion 23A.

### Liquid Agitating Apparatus

The container 200 can contain various types of liquid and can be used for image recording, maintenance of the ejection head 8, and the like. Depending on the type of ink, the coloring material (e.g., pigment components) in the ink may settle over time. For example, pigment components of pigment-based inks, which have high water resistance and light resistance, and titanium oxide components used in white inks are insoluble in water and therefore settle, accumulate, and coagulate at the bottom of a container due to gravity if left to stand for a long period of time. Therefore, in order to obtain a desired color, it is necessary to disperse the color-producing components evenly in the liquid while maintaining a predetermined particle size. In the present embodiment, by providing the liquid agitating apparatus 100, the liquid can be agitated to disperse the particles and improve the uniformity of the liquid. In particular, automating the agitating of the liquid can reduce the burden on the user.

### Overview of Apparatus

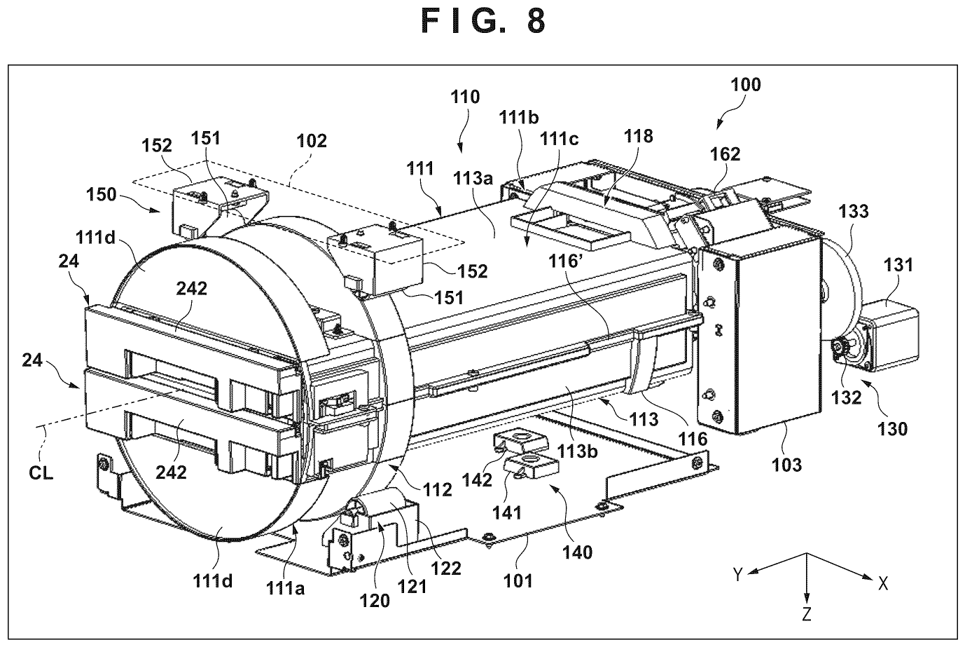

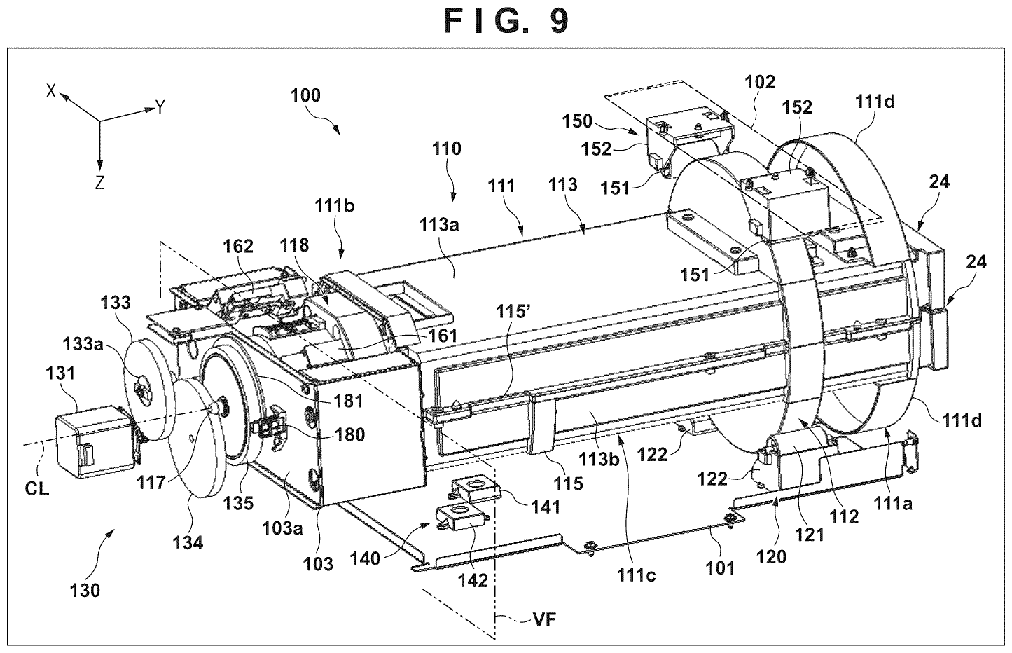

FIGS. 8 and 9 are perspective views of the liquid agitating apparatus 100, and more specifically, FIG. 8 is a perspective view of the liquid agitating apparatus 100 seen from the front side, and FIG. 9 is a perspective view of the liquid agitating apparatus 100 seen from the rear side.

The liquid agitating apparatus 100 includes a storing unit 110 that stores a liquid, a support unit 120 that rotatably supports the storing unit 110, and a drive unit 130 that rotates the storing unit 110 supported by the support unit 120. These components are supported to the main body 22 of the liquid storage device 20A by a frame that includes frames 101 to 103.

In the present embodiment, the liquid stored in the storing unit 110 is agitated by rotating the storing unit 110 around a rotation center line CL shown as a virtual line. By rotating the storing unit 110, the liquid can be agitated more effectively. The rotation center line CL is a line that passes through the storing unit 110 and, in the present embodiment, extends in the Y direction.

In the configuration of the present embodiment, two container support units 24 can be inserted into and removed from the storing unit 110 on the front side of the storing unit 110. This enables the liquids in two containers 200 to be agitated at the same time. The two container support units 24 are mounted to the storing unit 110 so as to be stacked one on top of the other. Note that the number of container support units 24 that can be mounted may be three or more, or may be one.

The drive unit 130 is disposed rearward of the storing unit 110, ensuring a relatively large space in front of the storing unit 110. This makes it easier for the user to insert and remove the container support units 24 into and from the storing unit 110. Furthermore, by adopting a structure in which the liquid agitating apparatus 100 as a whole extends in the Y direction, the size of the liquid agitating apparatus 100 in the X direction can be reduced.

### Storing Unit

FIGS. 8 and 9 will be referred to below. The storing unit 110 includes a storing member 111 and a shaft fixing member 118 that are connected in the direction of the rotation center line CL.

The storing member 111 is a hollow member that stores the containers 200. The storing member 111 has a front end portion 111a, which is at one end in the direction of the rotation center line CL (Y direction), and a rear end portion 111b, which is at the other end. An outer wall portion 111c of the storing member 111 is formed by a cylindrical portion 112 and rectangular tube portions 113, and is provided between the front end portion 111a and the rear end portion 111b. The cylindrical portion 112 is disposed closer to the front end portion 111a than the rear end portion 111b is, and the rectangular tube portions 113 are formed on the front end portion 111a side and the rear end portion 111b side of the cylindrical portion 112. The cylindrical portion 112 forms a cylindrical outer peripheral surface. The rectangular tube portions 113 have a substantially rectangular tube shape. A sector-shaped cover member 111d is attached to the front end portion 111a and covers components rearward of the front end portion 111a when the liquid agitating apparatus 100 is viewed from the front.

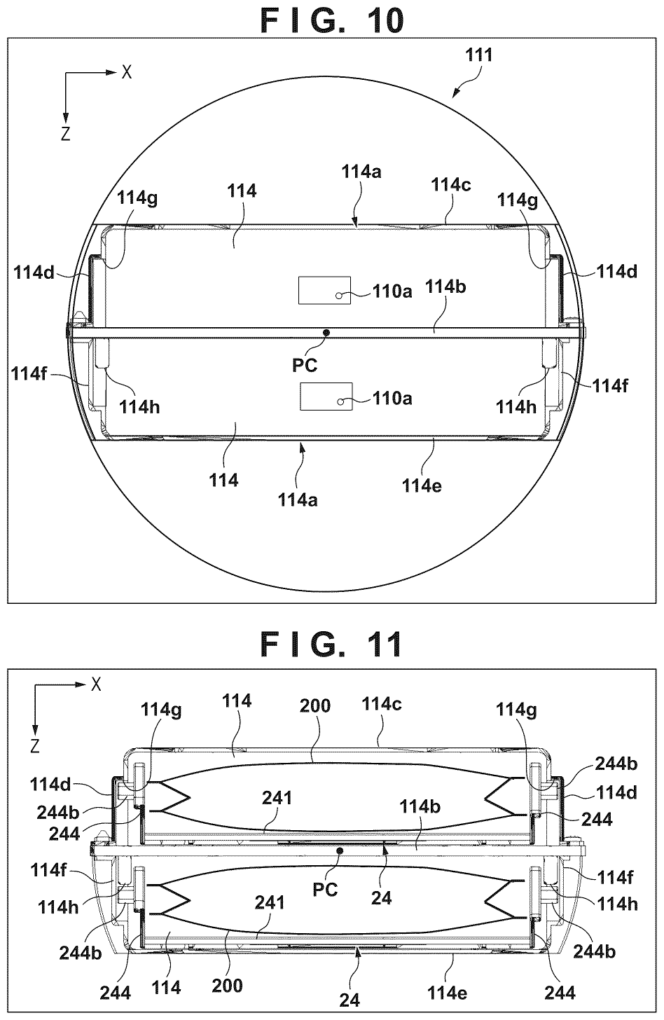

FIGS. 10 and 11 will also be referred to below in addition to FIGS. 8 and 9. FIG. 10 is a front view of upper and lower storage spaces 114 formed by the storing member 111, and shows a state in which the container support units 24 have been removed from the storage spaces 114. FIG. 11 also shows a front view of the upper and lower storage spaces 114, and in particular shows a state (cross-sectional shape) in which the container support units 24 are stored in the storage spaces 114. The storage spaces 114 extend over the entire area of the cylindrical portion 112 and the rectangular tube portions 113. Note that in the following description, unless otherwise specified, it is assumed that the storing unit 110 is in the initial position in descriptions related to directions.

The internal space of the storing member 111 is divided into two upper and lower sections by a partition wall 114b extending in the X-Y direction, and the storage spaces 114 extend along the rotation center line CL on the upper and lower sides of the partition wall 114b, respectively. Openings 114a, which serve as an entrance and exit for the storage spaces 114, are formed in the front end portion 111a of the storing member 111.

The container support units 24 are each displaceable in the Y direction between a storage position at which the container 200 is stored in the storage space 114 and a removed position at which the container 200 is exposed to the outside of the storing unit 110. In the removed position, the container 200 can be replaced. Since the containers 200 are replaceable, liquid refilling can be performed quickly, and the container support units 24 can be used repeatedly. Also, in the case of the present embodiment, there are almost no structures in the vicinity of the openings 114a that may get in the way of replacement work, thus making it easier to replace the containers 200.

Note that in the present embodiment, the container support unit 24 is separated from the storage space 114 at the removed position. However, the removed position may be a position at which an end of the container support unit 24 is held in the storage space 114, and may be any position at which the container 200 can be replaced in the container support unit 24.

The back side of the storage space 114 (the end portion 111b side of the storing member 111) is closed, and the needle member 110a protrudes in the Y direction from the back wall portion. When the container support unit 24 is inserted into the storage space 114, the needle member 110a is inserted into the supply port 201a of the container support unit 24. Inserting the needle member 110a into the supply port 201a forms a flow passage through which the liquid stored in the bag 202 supported by the container support unit 24 can flow out to the liquid ejection apparatus 1, which is the supply destination.

In the present embodiment, the storage space 114 is a flattened rectangular parallelepiped space that extends in the Y direction and whose height in the Z direction is shorter than the width in the X direction. Note that the storage space 114 may be a flattened rectangular parallelepiped space that extends in the Y direction and whose height in the Z direction is greater than the width in the X direction.

The upper storage space 114 is defined by a top wall 114c, left and right side walls 114d, and the partition wall 114b that serves as the bottom wall, and the lower storage space 114 is defined by a bottom wall 114e, left and right side walls 114f, and the partition wall 114b that serves as the top wall. The partition wall 114b, which forms the bottom wall of the upper storage space 114, and the bottom wall 114e of the lower storage space 114 can be provided with engagement portions corresponding to the engagement portion 234 that hold the container support units 24 in the storage position described with reference to FIG. 7.

The left and right side walls 114d of the upper storage space 114 are each provided with a guiding portion 114g. Each of the guiding portions 114g extends in the Y direction, and the cross-sectional shape is shaped as a stepped or inclined shoulder. When the container support unit 24 is inserted into or removed from the storage space 114, the guiding portions 114g function as rails that come into sliding contact with the ribs 244b of the container support unit 24, and guide the displacement of the container support unit 24 in the insertion/removal direction. Also, the guiding portions 114g abut against the ribs 244b in a direction intersecting the direction of the rotation center line CL (Z direction in the initial position), thereby restricting the container support unit 24 from being displaced in that intersecting direction. The container support unit 24 can be prevented from rattling within the storage space 114 when the storing unit 110 rotates.

Similarly, the left and right side walls 114f of the lower storage space 114 are each provided with a guiding portion 114h. The guiding portions 114h extend in the Y direction and are shaped as a protrusion that protrudes downward from the partition wall 114b. When the container support unit 24 is inserted into or removed from the storage space 114, the guiding portions 114h function as rails that come into sliding contact with the ribs 244b of the container support unit 24, and guide the displacement of the container support unit 24 in the insertion/removal direction. Also, the guiding portions 114h abut against the ribs 244b in a direction intersecting the direction of the rotation center line CL (Z direction in the initial position), thereby restricting the container support unit 24 from being displaced in that intersecting direction. The container support unit 24 can be prevented from rattling within the storage space 114 when the storing unit 110 rotates.

A rotation center PC of the storing unit 110 is located on the partition wall 114b. The rotation center PC is a point on the rotation center line CL. According to the configuration of the present embodiment, the rotation center line CL passes between the two storage spaces 114, and therefore the storing unit 110 can agitate the liquids in the two storage containers 200 more evenly.

### Rotation Support Structure

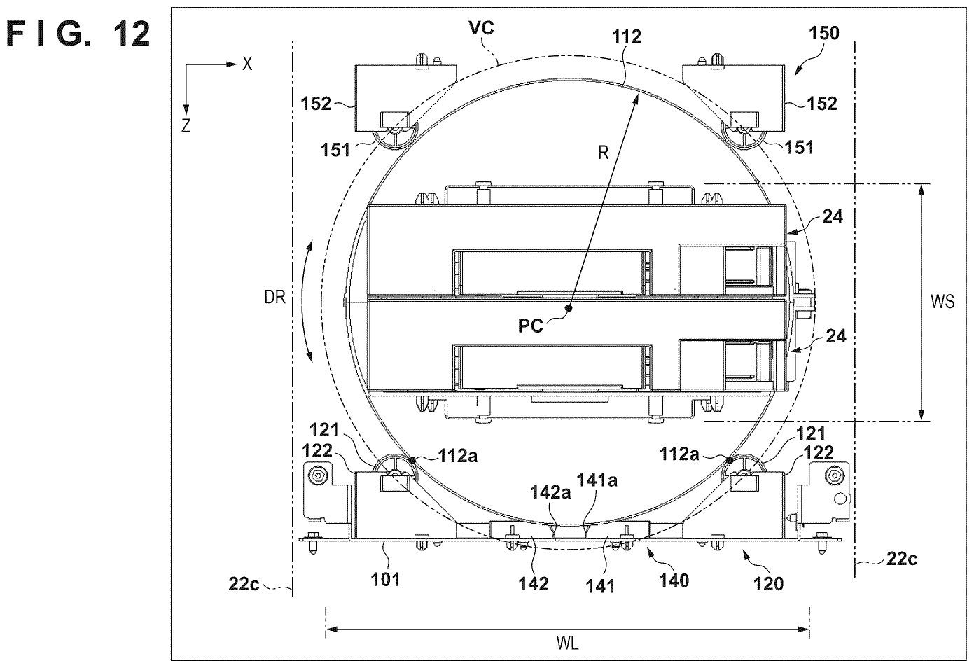

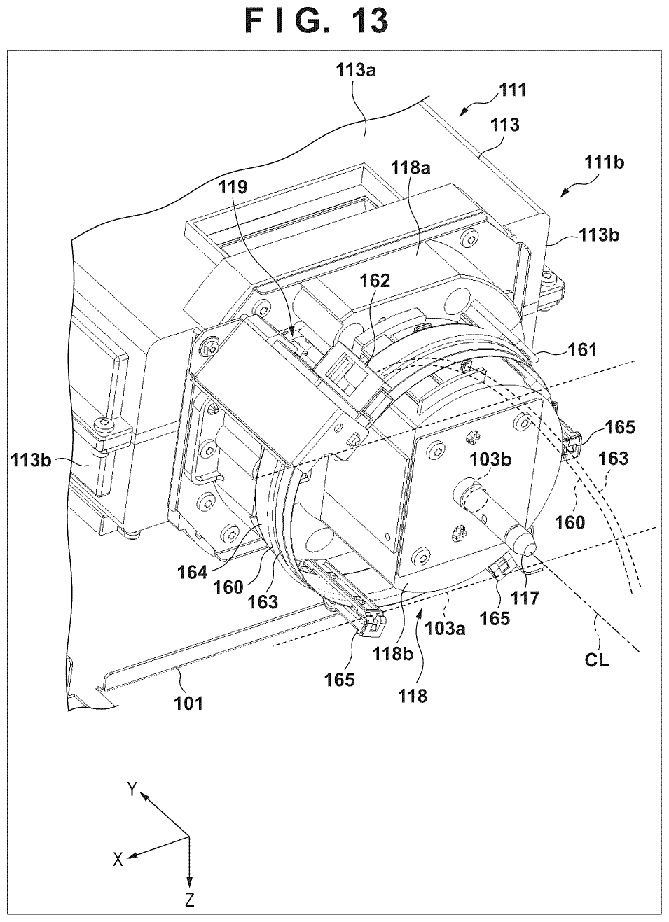

The structure for rotatably supporting the storing unit 110 will be described below with reference to FIGS. 8, 9, 12 and 13. FIG. 12 is a front view of the liquid agitating apparatus 100, mainly showing the rotation support structure for supporting the storing unit 110. FIG. 13 is a perspective view showing a rear portion of the storing unit 110 with the drive unit 130 removed.

The following describes problems related to the structure for rotatably supporting the storing unit 110. If the storing unit 110 is provided with shafts at both ends on the rotation center line CL, the presence of the shafts and bearings may reduce the degree of freedom in design and reduce user convenience. For example, in a structure in which the container support unit 24 can be inserted into and removed from the storing unit 110 as in the present embodiment, there are cases where there are constraints on the insertion and removal location and the insertion and removal direction. Furthermore, in a structure for storing and agitating a large volume of liquid, it is necessary to increase the rigidity of the shafts and bearings in consideration of the weight of the liquid.

In the present embodiment, such problems are solved by combining the support unit 120, which is a shaftless support structure, with a shafted support structure (shaft member 117 and bearing member 103a, which will be described later).

The support unit 120 is a mechanism that abuts against the outer wall portion 111c of the storing unit 110 so as to rotatably support the storing unit 110. The support unit 120 of the present embodiment supports the storing unit 110 so as to be rotatable around the rotation center line CL by a plurality of abutting portions 121 abutting against the cylindrical portion 112 of the storing member 111. In the present embodiment, the support unit 120 has two abutting portions 121, and these two abutting portions 121 abut against the cylindrical portion 112 at contact positions 112a spaced apart from each other in the circumferential direction of the cylindrical portion 112.

In the present embodiment, each of the abutting portions 121 is a roller supported by a bearing 122 around an axis in a direction parallel to the rotation center line CL (Y direction). The bearing 122 is supported by the frame 101. The circumferential surface of the abutting portion (roller) 121 abuts against the cylindrical portion 112, and the storing unit 110 is placed between the two abutting portions (rollers) 121 and can roll in place in the direction of an arrow DR in FIG. 12. Since the storing unit 110 is supported from below by the two abutting portions 121, even if the storing unit 110 contains a large volume of liquid and is heavy, structural stability is obtained without requiring significant reinforcement of rigidity.

The cylindrical portion 112 is closer to the front end portion 111a than the rear end portion 111b of the storing member 111 is, and the support unit 120 rotatably supports the storing unit 110 at a position closer to the front end portion 111a than the rear end portion 111b is. The storing unit 110 is supported by the shaftless support unit 120 in the vicinity of the openings 114a that serve as an entrance and exit for inserting and removing the container support units 24 into and from the storage spaces 114. Since there are no shafts or bearings in front of the liquid agitating apparatus 100, the user can more easily insert and remove of the container support units 24. Furthermore, when inserting and removing a container support unit 24, a load in the direction of gravity may easily act on the region surrounding the opening 114a. However, since the two abutting portions 121 support the storing unit 110 from below near the opening 114a, such a load can be stably received.

Furthermore, by giving the storing member 111 a structure having the cylindrical portion 112 and the rectangular tube portion 113, it is possible to reduce the weight and the moment of inertia of rotation compared to a case in which the entire member is formed from the cylindrical portion 112. The rectangular tube portion 113 has long-side portions 113a and short-side portions 113b that form the outline of the rectangle. In the present embodiment, the relationship between a width WL of the long-side portions 113a, a width WS of the short-side portions 113b, and a radius R of the cylindrical portion 112 is WL>WS and WS<2×R. By setting the width WS of the rectangular tube portion 113 smaller than the diameter (2×R) of the cylindrical portion 112, it is possible to reduce the weight and the moment of inertia during rotation.

On the other hand, the relationship WL>2×R is satisfied, and the cylindrical portion 112 and the contact positions 112a are located inside a virtual circle VC that passes through the outermost portion of the storing unit 110 and is centered about the rotation center PC. Therefore, the liquid agitating apparatus 100 can be made smaller. The side walls 22c of storage portion 23B can be brought closer to the storing unit 110, and the liquid agitating apparatus 100 can be made smaller in size in the X direction.

A shaft member 117 is provided at the rear portion of the storing unit 110 (on the rear end portion 111b side). The shaft member 117 is fixed to an end portion of a shaft fixing member 118, and extends along the rotation center line CL. The shaft fixing member 118 is a hollow body having a flange portion 118a that is fixed to the rear end portion 111b of the storing member 111 and having a body portion 118b that extends rearward from the flange portion 118a, and the shaft member 117 is fixed to the end portion of a body portion 118b. The frame 103 includes a plate-shaped bearing member 103a, and the shaft member 117 is supported by being inserted through a shaft hole 103b. By rotatably supporting the storing unit 110 not only by the support unit 120 but also by the shaft member 117 and the bearing member 103a, it is possible to prevent the rotation center PC of the storing unit 110 from wobbling, and more stable rotation can be achieved. Since the shaft member 117 and the bearing member 103a are located on the side of the storing unit 110 opposite to the openings 114a, the ease with which the user can insert and remove the container support units 24 is not impaired.

The liquid agitating apparatus 100 also includes a restriction unit 150 that restricts displacement of the storing member 111 in a direction intersecting the rotation center line CL. The restriction unit 150 of the present embodiment restricts the storing member 111 from becoming displaced upward in the Z direction. When a container support unit 24 is inserted or removed, if an upward force acts on the front side of the storing unit 110 and the storing unit 110 becomes inclined, a load acts on the shaft member 117 in the bending direction. By providing the restriction unit 150, such a change in posture can be prevented.

The restriction unit 150 of the present embodiment includes a plurality of abutting portions 151 that face the cylindrical portion 112 in the Z direction at a position above the rotation center line CL. When the storing member 111 is subjected to force for becoming displaced upward, the abutting portions 151 come into contact with the cylindrical portion 112, thereby physically preventing such displacement. The abutting portions 151 may be constantly in contact with the cylindrical portion 112, or may be normally located at positions slightly spaced apart in the Z direction.

In the present embodiment, the restriction unit 150 includes two abutting portions 151, and these two abutting portions 151 are arranged spaced apart from each other in the circumferential direction of the cylindrical portion 112. In the present embodiment, each of the abutting portions 151 is a roller supported by a bearing 152 around an axis parallel to the rotation center line CL (Y direction). The bearings 152 are supported by the frame 102.

The two abutting portions 151 are located at the same positions in the X direction and the Y direction as the two abutting portions 121 of the support unit 120. The set of two abutting portions 151 and bearings 152 can be constituted by the same components as the set of two abutting portions 121 and bearings 122 of the support unit 120. Using the same components makes it possible to reduce the number of types of components.

### Drive Unit

The structure of the drive unit 130 will be described below with reference to FIGS. 8 and 9. The drive unit 130 is disposed outward (rearward) of the rear end portion 111b of the storing member 111 in the direction of the rotation center line CL. By disposing the drive unit 130 on the side of the storing unit 110 opposite to the openings 114a, the number of mechanisms present around the openings 114a can be reduced, thereby improving the ease with which the user can insert and remove the container support units 24.

The drive unit 130 includes a motor 131 as a drive source. The motor 131 is fixed to a frame (not shown). A gear 132 is attached to the output shaft of the motor 131. In the present embodiment, the motor 131 is a step motor. The rotation rate of the storing unit 110 can be controlled by the rotation rate of the motor 131. The motor 131 may be a DC motor, in which case a rotation amount sensor such as a rotary encoder may be provided to control the rotation rate.

The drive unit 130 includes gears 133, 134 and 135. The gears 133 and 134 are rotatably supported by a frame (not shown). The gears 133 and 134 are each a double gear, the large gears of the gear 132 and the gear 133 are meshed with each other, and the small gear of the gear 133 is meshed with the large gear of the gear 134. Furthermore, the gear 135 is meshed with the small gear of the gear 134. A torque limiter 133a is provided between the small gear and the large gear of the gear 133 in order to be able to cut off the drive transmission therebetween. The torque limiter 133a can prevent the motor 131 from being subjected to an overload. Furthermore, if the user accidentally touches the storing unit 110 while the storing unit 110 is rotating, the torque limiter 133a cuts off the transmission of the driving force, thereby preventing a high load from being applied to the user's hand.

The gear 135 is fixed to the shaft member 117. When the motor 131 is driven, the driving force is transmitted to the shaft member 117, and the storing unit 110 thus rotates. The bearing member 103a is located between the gear 135 and the shaft fixing member 118, and the position of the storing unit 110 in the direction of the rotation center line CL is determined by these components. Although a gear mechanism is used as a mechanism for transmitting driving force from the motor 131 to the shaft member 117 in the present embodiment, other types of transmission mechanisms such as a belt transmission mechanism may also be used.

### Example of Agitating Operation

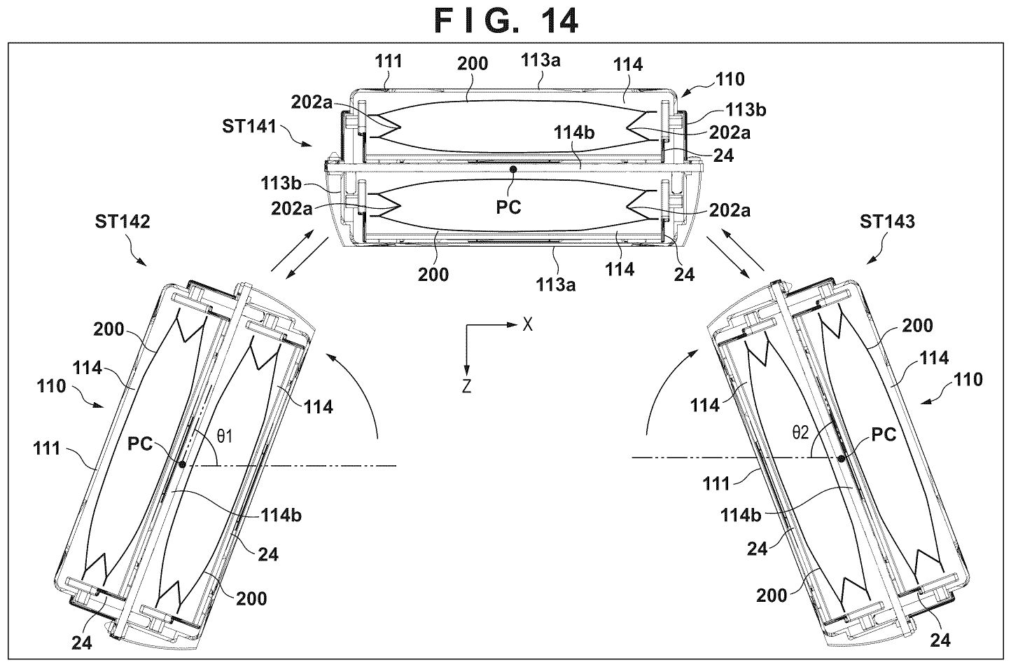

FIG. 14 shows an example of the agitating operation (rotation of the storing unit 110) performed by the driving of the drive unit 130. A state ST141 shows a state in which the storing unit 110 is in the initial position. In the initial position, the storing member 111 is in a horizontal posture in which the long-side portions 113a are horizontal. The support portions 240 of the container support units 24 and the containers 200 in the storage spaces 114 are also in a horizontal posture, and the gusset portions 202a on both sides of the containers 200 are positioned at the same height.

A state ST142 shows an inclined state in which the storing unit 110 has rotated counterclockwise from the initial position by an angle θ1. The position of the storing unit 110 in this state will be called the left inclined position. The gusset portions 202a on both sides of the containers 200 are in a state in which the gusset portions 202a on the right side in the figure are located higher than the gusset portions 202a on the left side. The liquid in the containers 200 flows from the gusset portions 202a on the right side to the gusset portions 202a on the left side.

A state ST143 indicates an inclined state in which the storing unit 110 has rotated clockwise from the initial position by an angle θ2. The position of the storing unit 110 in this state will be called the right inclined position. The gusset portions 202a on both sides of the containers 200 are in a state in which the gusset portions 202a on the left side in the figure are located higher than the gusset portions 202a on the right side. The liquid in the containers 200 flows from the gusset portions 202a on the right side to the gusset portions 202a on the left side.

The liquid in the containers 200 can be agitated by repeatedly changing the posture of the storing unit 110, for example, from the state ST141 to the state ST142, then to the state ST141, then to the state ST143, then to the state ST141 and so on.

When the posture of the storing unit 110 is changed from the state ST142 to the state ST143, the rotation may be temporarily stopped in the state ST141 during the change. Conversely, the rotation may not be stopped in the state ST141, and the posture of the storing unit 110 may be changed continuously from the state ST141 to the state ST143. This similarly applies to the case where the posture of the storing unit 110 is changed from the state ST143 to the state ST142.

Alternatively, a configuration is possible in which the posture of the storing unit 110 is changed continuously a plurality of times between the state ST142 and the state ST143 without stopping the rotation during the state ST141, and then the rotation is stopped for a predetermined time in the state ST141. This operation may then be repeated. By stopping the rotation for a predetermined time in the state ST141, the power consumption of the motor 131 can be reduced, and the uniformity of the liquid can be maintained by then resuming the rotation before the settling of particles in the liquid progresses.

The angle θ1 and the angle θ2 may be the same angle or may be different angles. The angle θ1 and the angle θ2 may be the same angle as each other when performing the agitating operation under one condition, and may be different angles when performing the agitating operation under another condition. When the angle θ1 and the angle θ2 are different angles, the magnitude relationship between them may be alternatingly switched between θ1>θ2 and θ1<θ2.

If the angles θ1 and θ2 are too small, the agitating effect decreases, whereas if they are too large, the containers 200 may become twisted. Therefore, the angles θ1 and θ2 may be, for example, angles selected from the range of 20 degrees or more to less than 90 degrees, or may be angles selected from the range of 60 degrees or more to 80 degrees or less. As one specific example, the angle may be 70 degrees.

The angles θ1 and θ2 may be different angles depending on the condition for starting the agitating operation. For example, a larger angle may be used under a condition in which it is estimated that settling is progressing, and a smaller angle may be used under conditions in which it is estimated that settling is not progressing.

Rotation of the storing unit 110 is controlled so as to accelerate from the stationary state, then rotate at a constant speed, and then decelerate to a stop. If the constant rotation speed (the rotation speed of the motor 131) is too fast, an excessive load may be applied to the containers 200, whereas if the constant rotation speed is too slow, agitation will become time-consuming. Therefore, the constant rotation speed may be, for example, a speed selected from the range of 20 deg/sec or more to 160 deg/sec or less, or may be a speed selected from the range of 30 deg/sec or more to 140 deg/sec or less. A relationship may be established between the constant rotation speed and the angles θ1 and θ2. For example, when the angles θ1 and θ2 are θα, the rotation speed may be V1, and when the angles θ1 and θ2 are θβ, which is larger than θα, the rotation speed may be V2, which is slower than V1. This makes it possible to reduce the load on the containers 200 while also maintaining the fluidity of the liquid.

### Structure for Restricting Rotation Range

If the storing unit 110 rotates excessively, there is a problem that the drive system may malfunction or the tube that discharges the liquid may become twisted, thus impeding the flow of the liquid. One possible cause of excessive rotation is, for example, when the user inserts or removes a container support unit 24 into or from the storing unit 110, the user may accidentally manually rotate the storing unit 110. The liquid agitating apparatus 100 of the present embodiment is provided with a structure for physically restricting the rotation range of the storing unit 110.

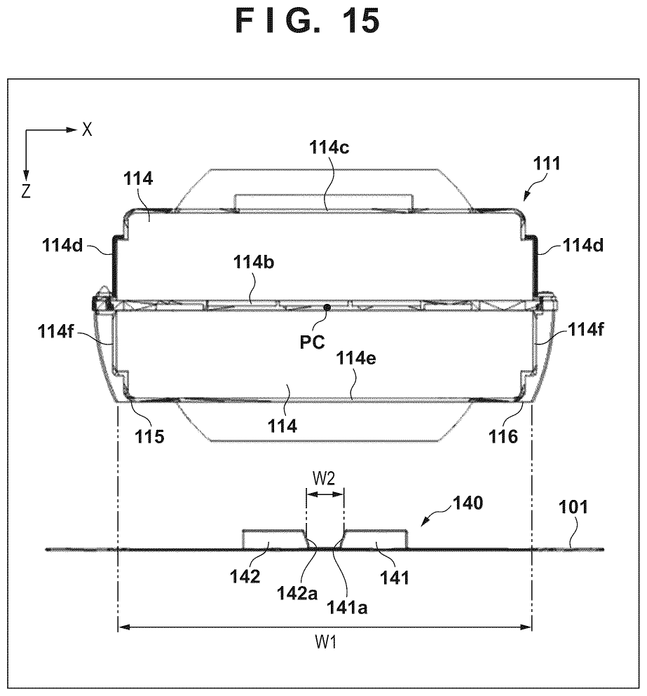

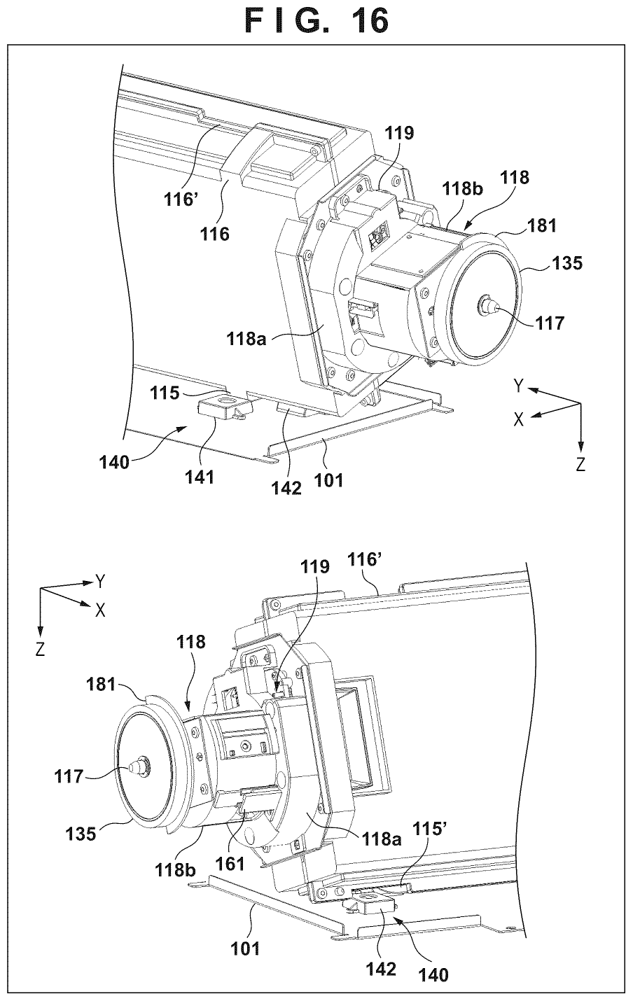

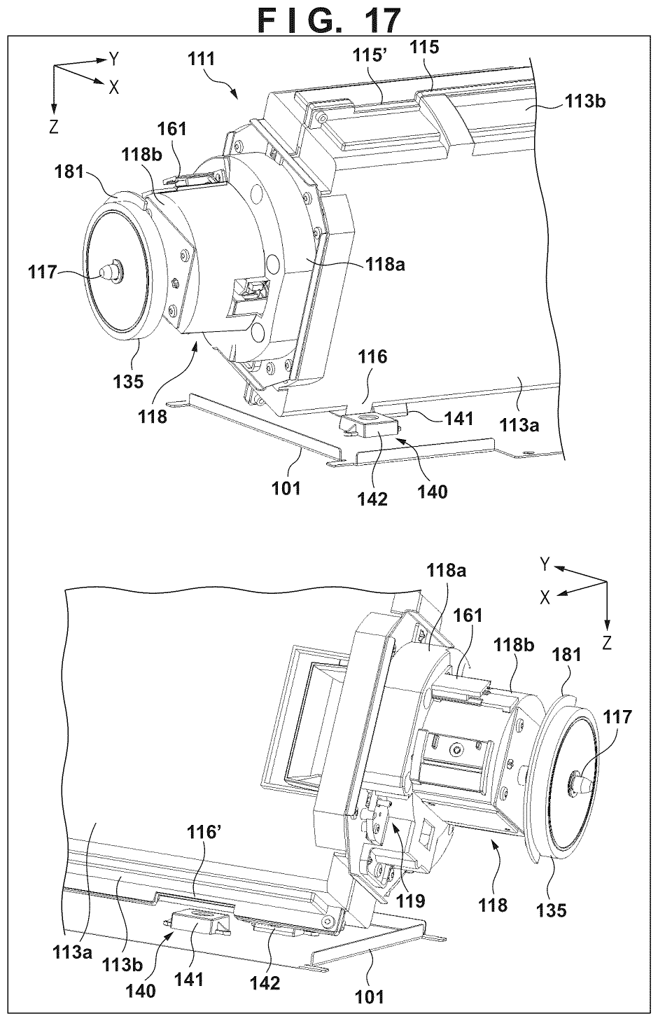

FIGS. 8, 9, 12, and 15 to 17 will be referred to below. FIG. 15 is an illustrative diagram of a rotation restriction unit 140, and FIGS. 16 and 17 are diagrams showing how rotation is restricted by the rotation restriction unit 140.

The liquid agitating apparatus 100 includes the rotation restriction unit 140 that restricts the rotation range of the storing unit 110. The rotation restriction unit 140 includes stoppers 141 and 142 that come into contact with the storing unit 110 to physically restrict the rotation thereof. By directly restricting the rotation of the storing unit 110 by abutting against the storing unit 110, excessive rotation of the storing unit 110 can be reliably prevented.

The stoppers 141 and 142 are block-shaped members fixed to the frame 101, and have inclined contact surfaces 141a and 142a. The stopper 141 abuts against an abutting portion 115 formed on the outer wall portion 111c of the storing unit 110, thereby defining the upper limit of the range of rotation of the storing unit 110 in one direction (rotation from the state ST141 to the state ST142 in FIG. 14). The stopper 142 abuts against an abutting portion 116 formed on the outer wall portion 111c of the storing unit 110, thereby defining the upper limit of the range of rotation of the storing unit 110 in the other direction (rotation from the state ST141 to the state ST143 in FIG. 14). In the present embodiment, the upper limit angles of the rotation ranges defined by the stoppers 141 and 142 are the same.

The abutting portions 115 and 116 are formed on the rectangular tube portion 113, and in particular, are formed on a long-side portion 113a, not on a short-side portion 113b. If the abutting portions protrude from the short-side portion 113b, the presence of the abutting portions tends to increase the diameter of the virtual circle VC shown in FIG. 12. This may lead to an increase in size of the liquid agitating apparatus 100 in the X direction and the Z direction. By forming the abutting portions 115 and 116 on portions of the long-side portion 113a, the liquid agitating apparatus 100 can be made smaller in size.

As shown in FIG. 12, the contact surfaces 141a and 142a of the stoppers 141 and 142 are located inside the virtual circle VC. In other words, the contact positions between the stoppers 141 and 142 and the abutting portions 115 and 116 in the radial direction of the rotation of the storing unit 110 (radial direction of the virtual circle VC) are located inside the virtual circle VC. The positions of the stoppers 141 and 142 in the X direction and the Z direction can be kept within a narrow range, and the liquid agitating apparatus 100 can be made smaller in size in the X direction and the Z direction.

As shown in FIG. 15, in a view in the direction of the rotation center line CL, based on the contact position, the abutting portion 115 and the abutting portion 116 are spaced apart by a distance W1 in the X direction, and the stopper 141 and the stopper 142 are spaced apart by a distance W2 in the X direction. The relationship between these distances is W1>W2. Since the arrangement range of the stopper 141 and the stopper 142 in the X direction falls within the width of storing member 111, liquid agitating apparatus 100 can be made compact in the X direction.

The abutting portions 115 and 116 are formed at end portions of the long-side portion 113a in the X direction (at the boundaries with the short-side portions 113b). Since the stoppers 141 and 142 are located relatively far from the rotation center PC, even if the rigidity of the stoppers 141 and 142 is relatively low, the rotation of the storing unit 110 can be restricted more reliably.

The stopper 141 and the stopper 142 are spaced apart from each other in the direction of the rotation center line CL (Y direction). In correspondence with the arrangement of the stoppers 141 and 142, the abutting portions 115 and 116 are also arranged spaced apart from each other in the direction of the rotation center line CL (Y direction). By shifting the positions of the stopper 141 and the stopper 142 in the direction of the rotation center line CL, even if the allowable range of rotation of the storing unit 110 is large, the distance between the stopper 141 and the stopper 142 in the X direction can be shortened. This allows the liquid agitating apparatus 100 to be made smaller in size in the X direction.

FIG. 16 is a perspective view showing, from two directions, a state in which the rotation of the storing unit 110 is restricted by the stopper 141 abutting against the abutting portion 115. When the abutting portion 115 comes into contact with the contact surface 141a of the stopper 141, the storing unit 110 is physically restricted from rotating further. The storing member 111 is provided with an interference avoiding portion 115′ adjacent to the abutting portion 115. In the present embodiment, the interference avoiding portion 115′ is a recession, thus avoiding interference between the abutting portion 116 and the storing member 111.

FIG. 17 is a perspective view showing, from two directions, a state in which the rotation of the storing unit 110 is restricted by the stopper 142 abutting against the abutting portion 116. When the abutting portion 116 comes into contact with the contact surface 142a of the stopper 142, the storing unit 110 is physically restricted from rotating further. The storing member 111 is provided with an interference avoiding portion 116′ adjacent to the abutting portion 116. In the present embodiment, the interference avoiding portion 116′ is a recession, thus avoiding interference between the abutting portion 115 and the storing member 111.

In the present embodiment, the rotation range of the storing unit 110 is restricted by the stoppers 141 and 142 abutting against the storing member 111, but the rotation range may be restricted using other portions. For example, the rotation range of the storing unit 110 may be restricted by a stopper abutting against the gear 133, the gear 134, or the gear 135 of the drive unit 130 to restrict the rotation thereof.

### Rotation Position Detection

The storing unit 110 can be touched by the user, and the position of the storing unit 110 may shift when the liquid agitating apparatus 100 is turned off. Furthermore, in the present embodiment, since the torque limiter 133a is provided in the drive transmission path of the drive unit 130, an error may arise between the rotation amount of the motor 131 and the rotation position of the storing unit 110. If there is a large error in the recognition of the rotational position of the storing unit 110, the rotational control of the storing unit 110 may not be performed accurately during the agitating operation. In the present embodiment, a sensor for detecting the position of the storing unit 110 is provided, thereby improving the accuracy of recognizing the rotational position of the storing unit 110.

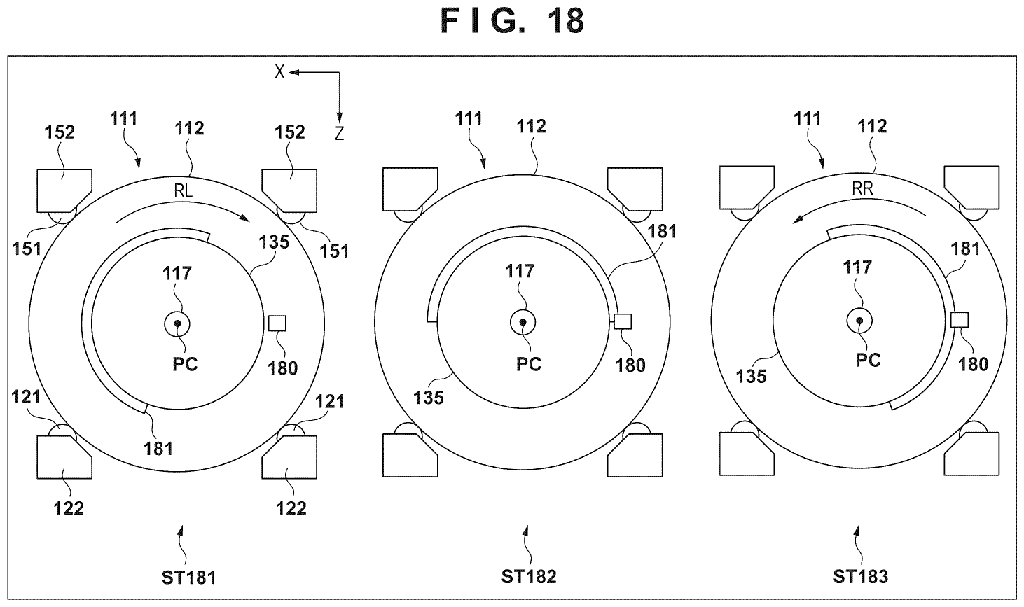

FIGS. 9, 16, 17 and 18 will be referred to below. FIG. 18 is an illustrative diagram of operations for detecting the position of the storing unit 110.

The storing unit 110 is provided with the detection piece 181 that rotates around the rotation center line CL together with the storing unit 110. In the present embodiment, the detection piece 181 is integrated with the gear 135, and is fixed to the shaft member 117 with use of the gear 135. A sensor 180 for detecting the detection piece 181 is fixed to the frame 103. The sensor 180 is, for example, an optical sensor, and detects whether or not the detection piece 181 is present at the detection position of the sensor 180. When the storing unit 110 is viewed from the rear, the detection position is the 3 o'clock position if likened to a clock face centered on the rotation center PC (see FIG. 18).

The detection piece 181 includes a portion that extends around the rotation center line CL, and the sensor 180 detects the detection piece 181 when the rotation position of the storing unit 110 is within a certain rotation range. In the present embodiment, the detection piece 181 has an arc shape (or a sector shape) centered on the rotation center line CL, and particularly in the present embodiment, has a semicircle arc shape.

In the present embodiment, the position at which the edge of the detection piece 181 crosses the sensor 180 (the position at which the detection result changes from non-detection to detection, for example) is set as a reference position. In the present embodiment, the reference position corresponds to the initial position of the storing unit 110 (the state ST141 in FIG. 14). A state ST182 in FIG. 18 shows the positional relationship between the detection piece 181 and the sensor 180 when the storing unit 110 is at the initial position.

The detection piece 181 is provided such that the detection piece 181 can be detected by the sensor 180 while the storing unit 110 moves from the initial position to the left inclined position shown in the state ST142 of FIG. 14. A state ST183 in FIG. 18 shows a position at which the storing unit 110 is midway through rotation from the initial position to the left inclined position (the state ST142) in FIG. 14.

The detection piece 181 is provided such that the detection piece 181 is not detected by the sensor 180 while the storing unit 110 moves from the initial position to the right inclined position shown in the state ST143 of FIG. 14. A state ST181 in FIG. 18 shows a position at which the storing unit 110 is midway through rotation from the initial position to the right inclined position (the state ST143) in FIG. 14.

An example of processing performed using the detection result of the sensor 180 will be described below. This processing can be executed by a control unit 32, which will be described later. First, an example of initialization processing for rotating the storing unit 110 to the initial position will be described below with reference to FIG. 18. The initialization processing can be performed, for example, when the liquid agitating apparatus 100 is powered on. The initialization processing can also be performed periodically after the liquid agitating apparatus 100 is powered on, for example,.

In the initialization processing, first, the detection result of the sensor 180 is obtained, and it is determined whether or not the detection piece 181 was detected. If the detection piece 181 is not detected as shown in the state ST181 of FIG. 18, it can be determined that the storing unit 110 is in a position rotated toward the right inclined position (the state ST143 of FIG. 14) from the initial position. Therefore, the storing unit 110 is rotated in the direction of an arrow RL by the drive unit 130, and the rotation of the storing unit 110 is stopped at the position at which the detection result of the sensor 180 changes from non-detection to detection. The storing unit 110 becomes located at the initial position.

If the detection piece 181 is detected as shown in the state ST183 of FIG. 18, it can be determined that the storing unit 110 is in a position rotated toward the left inclined position side (the state ST142 side of FIG. 14) from the initial position. Therefore, the storing unit 110 is rotated in the direction of an arrow RR by the drive unit 130. After passing the position at which the detection result of the sensor 180 changes from detection to non-detection, the rotation direction of the storing unit 110 is reversed, and the storing unit 110 is stopped at the position at which the detection result of the sensor 180 changes from non-detection to detection. The storing unit 110 becomes located at the initial position.

In this manner, in the present embodiment, by making the shape of the detection piece 181 correspond to the rotational position of the storing unit 110, it is possible to determine the rotational direction in which the storing unit 110 has been rotated relative to the initial position based on the detection result of the sensor 180. As a result, initialization processing can be completed quickly.

Next, an example of error processing regarding rotation of the storing unit 110 during the agitating operation will be described. In the agitating operation illustrated in FIG. 14, every time the storing unit 110 passes through the initial position (the state ST141), the detection result of the sensor 180 switches from non-detection to detection, or from detection to non-detection. If the detection result of the sensor 180 does not change even when the motor 131 has rotated a predetermined amount, it can be determined that a foreign object has interfered with the drive unit 130 or the storing unit 110 and prevented rotation.

If it is determined that rotation is impossible, error processing can be performed, such as stopping the driving of the motor 131 and notifying the user. For example, a message is displayed via the operation panel 10 or the host computer 300 to power off the liquid ejection apparatus 1 or the liquid agitating apparatus 100 for initialization, or the message is announced by voice or the like. Alternatively, an error code may be displayed via the operation panel 10 or the host computer 300 so as to guide the user to make a service call, or the error code may be notified by voice or the like.

Note that in the present embodiment, the detection piece 181 is integrated with the gear 135, but the location of the detection piece 181 is not limited to the gear 135. For example, the detection piece 181 may be provided on the storing member 111, for example, such as being provided on the cylindrical portion 112, for example.

### Liquid Discharge Structure

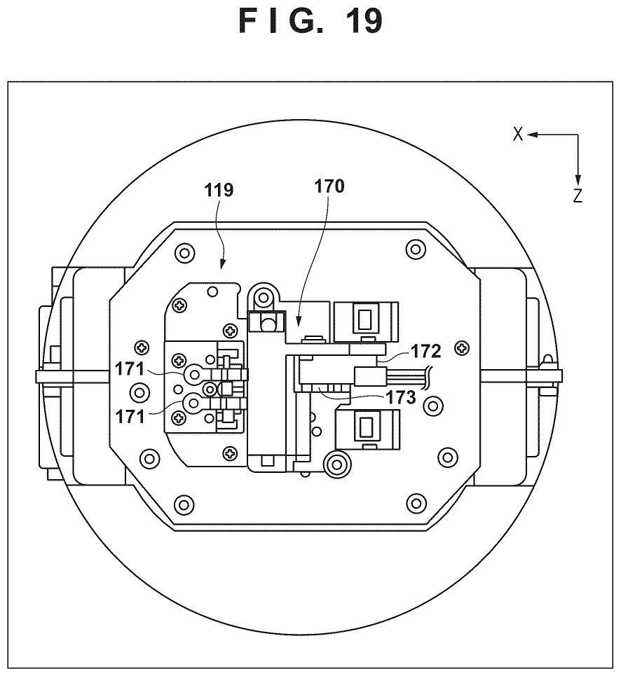

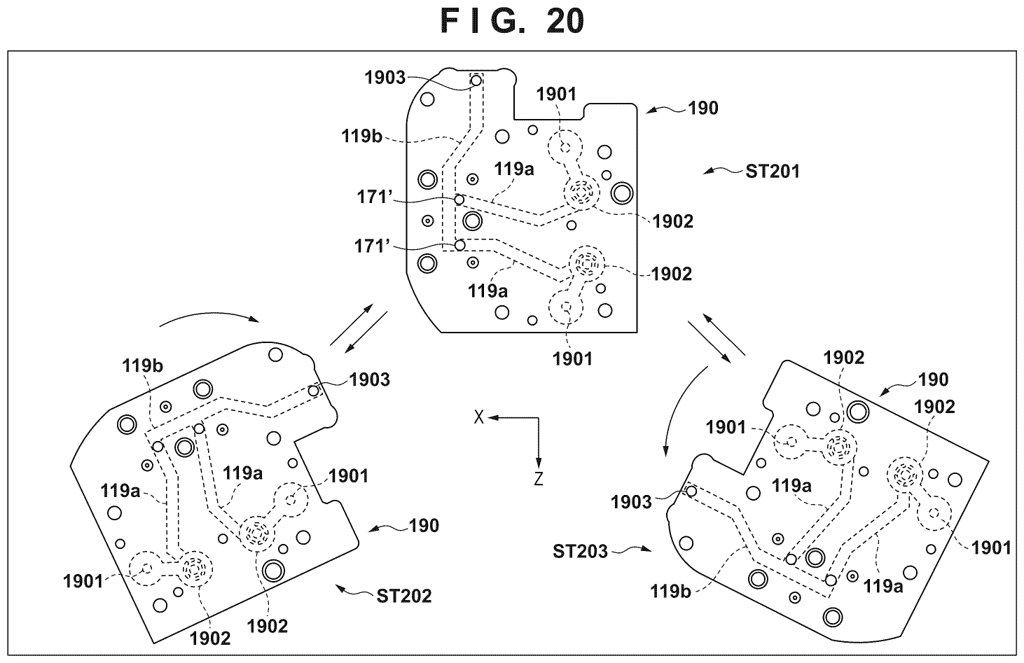

The structure for discharging liquid from the container 200 via the needle member 110a will now be described. Between the rear end portion 111b of the storing member 111 and the shaft fixing member 118, a flow passage forming member 119 is provided at the rear end portion 111b. FIG. 19 is a diagram showing the flow passage forming member 119 and a valve unit 170 at the rear end portion 11b of the storing member 111, with the shaft fixing member 118 removed from the rear end portion 111b. FIG. 20 shows an example of a flow passage formed by the flow passage forming member 119 and how the posture of the flow passage forming member 119 changes as the storing unit 110 rotates.

First, FIG. 20 will be referred to below. The flow passage forming member 119 forms a liquid flow passage 119b and two liquid flow passages 119a branching from the flow passage 119b. An outlet hole 1903 is formed at the end of the flow passage 119b. At the end of each of the flow passages 119a, a communication hole 1901 is formed in communication with the needle member 110a in the corresponding upper or lower storage space 114. A check valve 1902 is formed at an intermediate position in the flow passage 119a. The liquid in the container 200 flows out of the storing unit 110 through the needle member 110a, the communication hole 1901, the flow passage 119a, the flow passage 119b, and the outlet hole 1903 in this order.

A state ST201 shows the posture of the flow passage forming member 119 when the storing unit 110 is at the initial position. A state ST202 shows the posture of the flow passage forming member 119 when the storing unit 110 is in the left inclined position (the state ST142 in FIG. 14). A state ST203 shows the posture of the flow passage forming member 119 when the storing unit 110 is in the right inclined position (the state ST143 in FIG. 14).

If the liquid agitating apparatus 100 has not been operated for a long period of time with the storing unit 110 at the initial position, particles contained in the liquid may settle around the branch points between the flow passage 119b and the two flow passages 119a. However, in the present embodiment, when the storing unit 110 rotates due to the agitating operation, the flow passage forming member 119 also rotates, and the posture thereof changes. Since the inclination of the flow passages 119a and 119b changes, particles that have settled around the branch points can easily flow together with the liquid, and the flow passages 119a and 119b can be prevented from becoming blocked by particles.

The valve unit 170 shown in FIG. 19 is a motor-operated valve that switches between closing and opening the flow passages 119a at positions 171′in the vicinity of the branch points between the flow passage 119b and the two flow passages 119a. The valve unit 170 includes two valve elements 171 corresponding to the two positions 171′, a motor 172 serving as a drive source, and a position sensor 173 that detects the positions of the two valve elements 171. A cam mechanism (not shown) built into the valve unit 170 is operated by the motor 172 to drive the valve elements 171, thereby switching between closing and opening the flow passages 119a.

The valve unit 170 makes it possible to select between closing both of the two flow passages 119a and opening one of them. For example, when containers 200 containing the same type of liquid are housed in the two storage spaces 114, liquid is supplied from one of the containers 200 and the supply of liquid from the other container 200 is stopped. When the liquid in the one container 200 runs out, liquid is supplied from the other container 200, and the supply of liquid from the one container 200 is stopped. The empty container 200 can then be replaced with a new container 200.

### Tube Arrangement Structure

A flexible tube is connected to the outlet hole 1903, and the liquid is supplied to the liquid ejection apparatus 1 through the tube. As shown in FIG. 20, when the storing unit 110 rotates, the flow passage forming member 190 also rotates, and the position of the outlet hole 1903 changes. It is necessary to prevent the tube from twisting or behaving in an unintended manner as a result of this position change, which could lead to contact with and damage to a surrounding structure. In the present embodiment, such a problem is solved by adopting a structure for controlling the behavior of the tube accompanying the rotation of the storing unit 110.

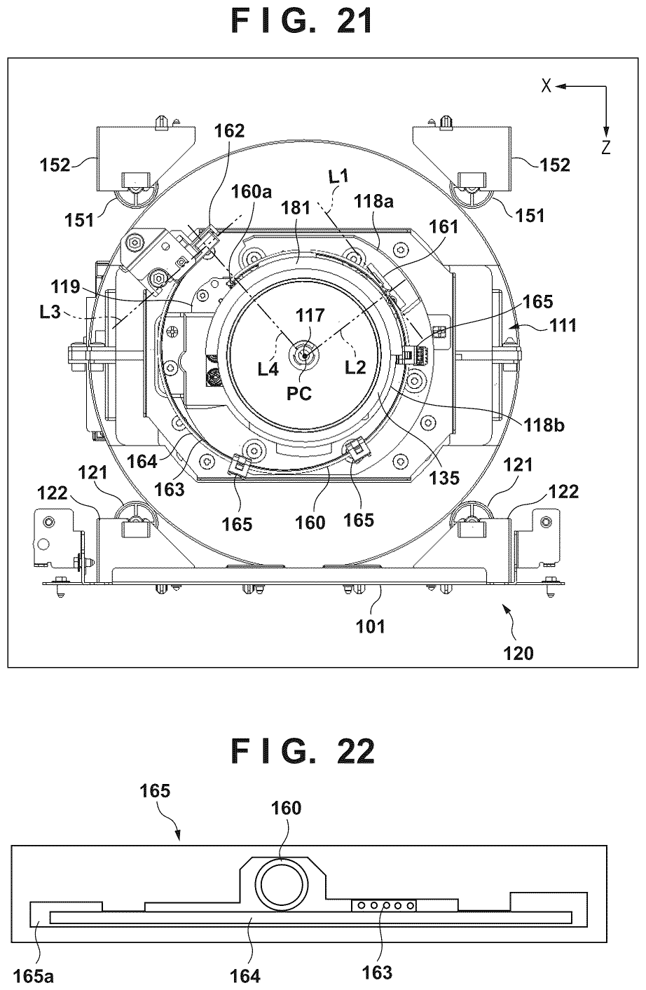

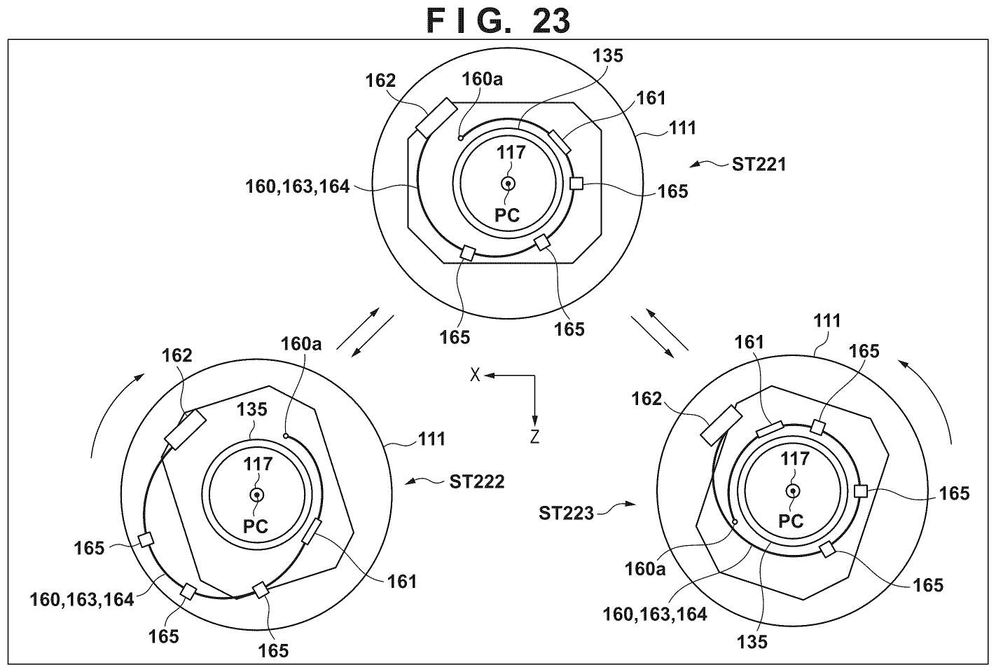

FIGS. 9, 13, 16, 17, and 21 to 23 will be referred to below. FIG. 21 is a rear view showing a rear portion of the storing unit 110, with the drive unit 130 removed, except for the gear 135. FIG. 22 is an illustrative diagram of the holding member 165. FIG. 23 is a diagram showing an example of change in the shape of the tube 160 and the like when the storing unit 110 is rotated.

The tube 160 has one end portion 160a connected to an outlet hole 2903, and extends from the storing unit 110. The tube 160 forms a discharge flow passage for liquid to be discharged from the storing unit 110 (i.e., liquid in the container 200). A fixing member 161 is provided in the vicinity of the body portion 118b of the shaft fixing member 118. The fixing member 161 is a clip-type member that clamps an intermediate portion of the tube 160 and fixes the intermediate portion of the tube 160 to the storing unit 110. The fixing member 161 rotates around the rotation center line CL together with the storing unit 110.

The frame 103 includes a fixing member 162. The fixing member 162 is a clip-type member that fixes an intermediate portion of the tube 160 downstream of the fixing member 161 in the outflow direction of the liquid. The fixing member 162 is fixed to the frame 103 and is therefore a stationary member that does not rotate together with the storing unit 110. As shown in FIG. 9, the fixing members 161 and 162 are disposed on a virtual plane VF that is orthogonal to the rotation center line CL. In the present embodiment, the fixing members 161 and 162 are arranged on the same virtual plane, but the virtual plane VF on which the fixing member 161 is arranged and the virtual plane VF on which the fixing member 162 is arranged may be shifted from each other in the direction of the rotation center line CL. In this case, the tube 160 may be arranged in a spiral shape extending in the direction of the rotation center line CL.

When the storing unit 110 is at the initial position, as shown in FIG. 21, if likened to a clock face centered on the rotation center PC, the fixing member 161 is at the 2 o'clock position and the fixing member 162 is at the 10 o'clock position. The tube 160 passes clockwise from the end portion 160a, above the body portion 118b, reaches the fixing member 161, and then passes further clockwise below the body portion 118b, and reaches the fixing member 162. The tube 160 then extends further from the fixing member 162 (FIG. 13). In FIGS. 21 and 22, only the section of the tube 160 from the end portion 160a to the fixing member 162 is shown. The fixing member 161 and the fixing member 162 are disposed inward of at least the cylindrical portion 112 when viewed from the Y direction. This makes it possible to reduce the moving area in the X direction of the tube 160 which rotates in conjunction with the rotation of the storing unit 110.

The fixing member 161 fixes an intermediate portion of the tube 160 so as to face in a tangential direction L1 rather than a radial direction L2 of a virtual circle on the X-Z plane centered on the rotation center PC, and in the present embodiment, this intermediate portion faces in the tangential direction L1. Similarly, the fixing member 162 fixes an intermediate portion of the tube 160 so as to face in a tangential direction L3 rather than a radial direction L4 of a virtual circle on the X-Z plane centered on the rotation center PC, and in the present embodiment, this intermediate portion faces in the tangential direction L13. Therefore, in the tube section of the tube 160 from the end portion 160a to the fixing member 161, and in the tube section from the fixing member 161 to the fixing member 162, the tube 160 is arranged in an arc shape or a spiral shape around the rotation center line CL. The fixing member 161 and the fixing member 162 are configured to fix the tube 160 substantially parallel to the tangential directions L1 and L3, respectively. This makes it possible to guide the spreading direction of the tube 160, which rotates in conjunction with the rotation of the storing unit 110, in the direction of gravity, and damage to the tube 160 can be suppressed by reducing the load on the tube 160. This reduces the spreading of the tube 160 in the X direction, making it possible to reduce the size of the space in the X direction in which the tube 160 extends.

In the present embodiment, the tube 160 is routed together with an electrical cable (e.g., a flexible flat cable) 163 and a flexible band member 164 in the tube section from the fixing member 161 to the fixing member 162.

The electrical cable 163 includes wiring for electrical components provided in the storing unit 110, such as electrical wiring for the motor 172 and the position sensor 173, for example. Similarly to the tube 160, the electrical cable 163 has an intermediate portion fixed by the fixing member 161 and an intermediate portion on the downstream side fixed by the fixing member 162. In the cable section from the fixing member 161 to the fixing member 162, the electrical cable 163 is routed in an arc shape or a spiral shape around the rotation center line CL. The tube 160, the electrical cable 163, the fixing member 161, and the fixing member 162 are arranged closer to the rear end portion 111b than the front end portion 111a of the storing member 111, and particularly behind the rear end portion 111b in the present embodiment. These configurations do not get in the way when the user inserts and removes the container support unit 24 on the front end portion 111a side, thereby improving user convenience.

The band member 164 is, for example, a polyester film. The band member 164 supports the tube 160 and the electrical cable 163, and further stabilizes the behavior of the tube 160 and the electrical cable 163 when the storing unit 110 rotates, and the band member 164 extends from the fixing member 161 to the fixing member 162.

In order to route the tube 160 and the electrical cable 163 together with the band member 164, a plurality of holding members 165 are used. The holding members 165 are arranged in the section from the fixing member 161 to the fixing member 162, and are bundling members that integrally bundle the tube 160, the electrical cable 163, and the band member 164. FIG. 23 is an illustrative diagram showing the structure of the holding member 165, which has a configuration in which the respective intermediate portions of the tube 160, the electrical cable 163 and the band member 164 are sandwiched in a gap 165a. The holding member 165 can prevent the tube 160, the electrical cable 163, and the band member 164 from coming apart.

The behavior of the tube 160, the electrical cable 163, and the band member 164 (hereinafter, referred to as the tube 160 etc.) when the storing unit 110 rotates will be described below with reference to FIG. 23. A state ST221 shows a state in which the storing unit 110 is at the initial position. In the space between the fixing member 161 and the fixing member 162, the tube 160 etc. have an appropriate amount of play or slack.

A state ST222 shows the state of the tube 160 etc. when the storing unit 110 is in the left inclined position (the state ST142 in FIG. 14). In comparison with a state ST221, in the state ST222, the length of the section between the fixing member 161 and the fixing member 162 in the clockwise direction in the figure is shorter, and the two are closer to each other. The amount of play or slack in the tube 160 etc. increases in the section from the fixing member 161 to the fixing member 162, and the radius of the circular arc described by this section increases.

A state ST223 shows the state of the tube 160 etc. when the storing unit 110 is in the right inclined position (the state ST143 in FIG. 14). In comparison with a state ST221, in the state ST223, the length of the section between the fixing member 161 and the fixing member 162 in the clockwise direction in the figure is longer, and the two are spaced apart. The amount of play or slack in the tube 160 etc. is reduced in the section from the fixing member 161 to the fixing member 162, and the radius of the circular arc described by this section becomes smaller. The tube 160 etc. is close to the peripheral surface of the body portion 118b but does not come into contact with it, and the tube 160 etc. does not come into contact with the valve unit 170 either.

In this manner, in the present embodiment, by adopting an arrangement in which the radius of the arc described by the tubes 160 etc. changes depending on the direction of rotation of the storing unit 110, the behavior of the tubes accompanying the rotation of the storing unit 110 can be controlled. As a result, twisting of the tube 160 etc. or other unintended behavior can be prevented.

### Control Circuit

The configuration of a control circuit of the system A will be described below with reference to FIG. 24. FIG. 24 is a block diagram of the control circuit of the system A. A main control unit 30 performs overall control of the system A in accordance with instructions from a host computer 300 and an operation panel 10. The control unit 31 controls the liquid ejection apparatus 1 based on instructions from the main control unit 30, and the control unit 32 controls the liquid storage devices 20A and 20B based on instructions from the main control unit 30. The main control unit 30 and the control units 31 and 32 each include, for example, at least one processor, at least one storage device, and at least one input/output interface. The storage device is, for example, a semiconductor memory such as a RAM or a ROM. The input/output interface performs input and output of signals between the processor and external devices (e.g., sensors and motors).

A discharge control unit 35 controls the ejection head 8, in particular, controls the discharge of liquid. An actuator group 34 includes a conveying motor that is the drive source for the conveying unit 6, a carriage motor that is the drive source for the moving mechanism of the carriage (not shown), a winding motor that is the drive source for the winding unit 5, and a recovery motor that is the drive source for the recovery unit 9. Furthermore, the actuator group 34 includes, for example, a cutter motor that is a drive source for a cutter (not shown) that cuts the recording medium M after an image is recorded thereon. A sensor group 33 includes various sensors provided in the liquid ejection apparatus 1.

A clock unit 38 is a counter that outputs the count result of the elapsed time to the control unit 32. When the liquid agitating period is managed by time, the count result of the clock unit 38 can be used. An agitation timing can also be determined using the counting result of the clock unit 38.

The actuator group 37 includes the motors 131 and 172, the flow passage valve 232, and the like that are provided in the liquid agitating apparatus 100. The sensor group 36 includes, for example, the sensors 26 and 180 provided in the liquid agitating apparatus 100.

### Example of Processing of Control Circuit

An example of processing executed by the control unit 32 regarding the agitating operation will be described below. Here, the agitating operation performed using the rotation restriction unit 140 will be described. The rotation restriction unit 140 is a structure that physically restricts the rotation range of the storing unit 110 as described above. Also, by intentionally causing the abutting portion 115 and the abutting portion 116 to collide with the stoppers 141 and 142, it is possible to apply impact to the storing unit 110 and improve the agitation effect of the liquid. However, when the abutting portion 115 and the abutting portion 116 come into contact with the stoppers 141 and 142, a hitting sound may be generated. Therefore, an operation condition is determined in advance, and depending on whether or not the operation condition is established, one of the following rotation operations, which have different rotation ranges of the storing unit 110, is performed.

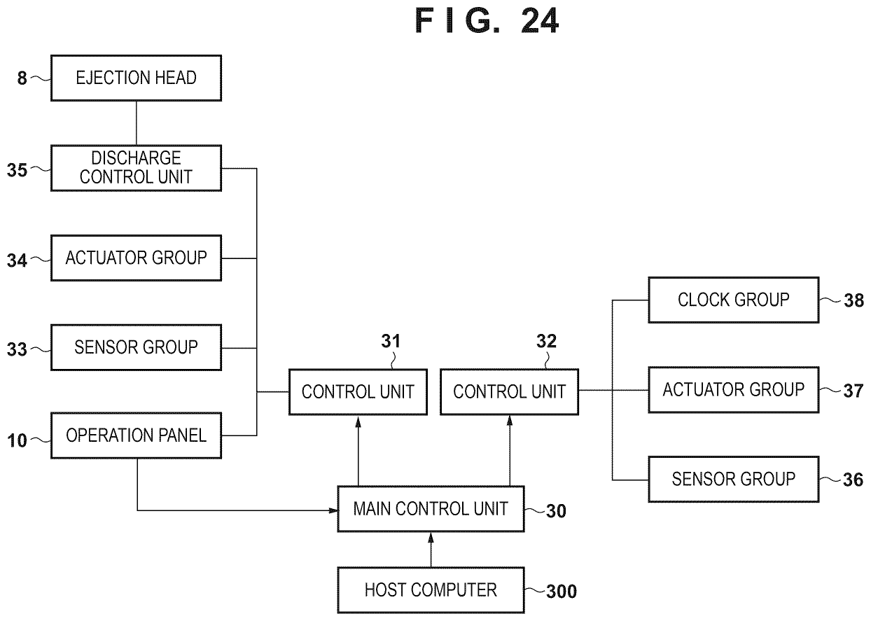

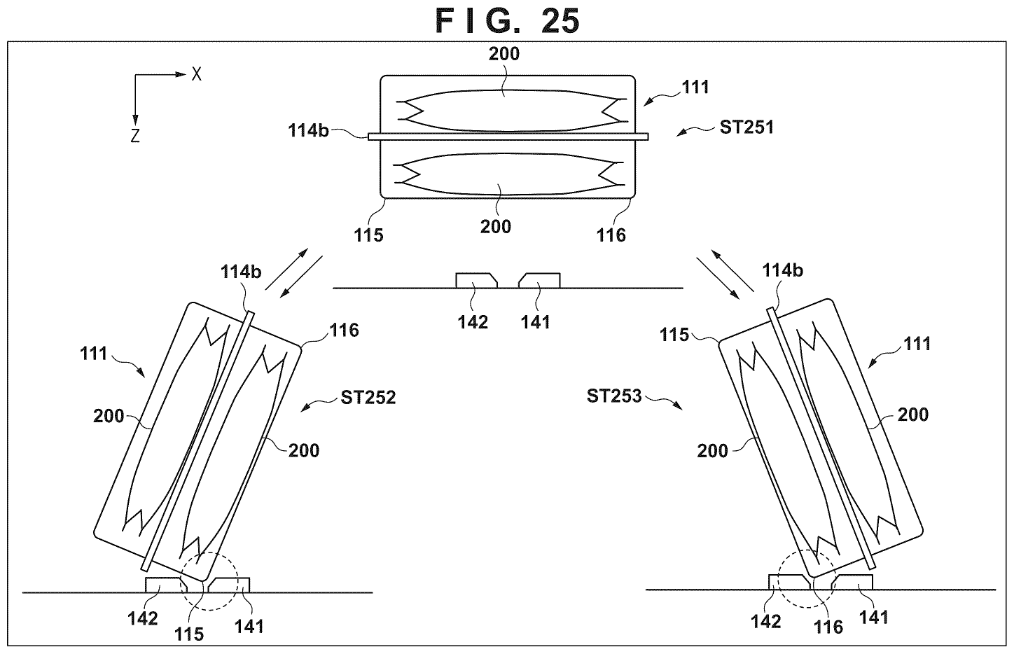

FIG. 25 shows an example of rotational movement of the storing unit 110 when normal agitation is to be performed. A state ST251 shows a state in which the storing unit 110 is at the initial position. A state ST252 shows a state in which the storing unit 110 is rotated to the left inclined position. At this time, before the abutting portion 115 comes into contact with the stopper 141, the rotation direction of the storing unit 110 is switched to the reverse direction. As one example, the rotation amount of the motor 131 is controlled so that the rotation of the storing unit 110 stops before the abutting portion 115 comes into contact with the stopper 141, and then the motor 131 is rotated in the reverse direction. Since the abutting portion 115 does not come into contact with the stopper 141, the generation of hitting noise can be prevented.

A state ST253 shows a state in which the storing unit 110 is rotated to the right inclined position. Similarly, before the abutting portion 116 comes into contact with the stopper 142, the rotation direction of the storing unit 110 is switched to the reverse direction. As one example, the rotation amount of the motor 131 is controlled so that the rotation of the storing unit 110 stops before the abutting portion 116 comes into contact with the stopper 142, and then the motor 131 is rotated in the reverse direction. Since the abutting portion 116 does not come into contact with the stopper 142, the generation of hitting noise can be prevented.

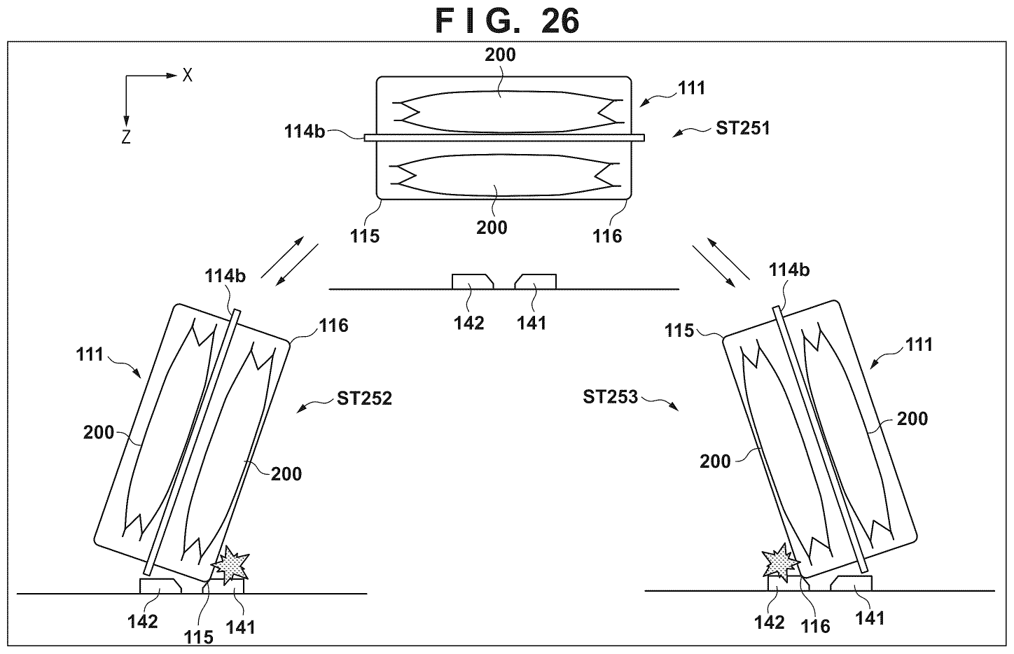

FIG. 26 shows an example of rotational movement of the storing unit 110 when high agitation is to be performed. This rotation operation is performed, for example, when the system A is turned on, when the liquid agitating apparatus 100 is turned on, when the container 200 is replaced, or when the container 200 that has been stored stationary for a long period of time is used.

A state ST261 shows a state in which the storing unit 110 is at the initial position. A state ST262 shows a state in which the storing unit 110 is rotated to the left inclined position. At this time, after the abutting portion 115 comes into contact with the stopper 141, the rotation direction of the storing unit 110 is switched to the reverse direction. As one example, the rotation amount of the motor 131 is controlled so that the rotation of the storing unit 110 continues until the abutting portion 115 comes into contact with the stopper 141, and then the motor 131 is stopped and rotated in the reverse direction. As the abutting portion 115 comes into contact with the stopper 141, impact is applied to the storing unit 110, and the agitation performance of the liquid in the container 200 is improved. Even if an impact acts on the storing unit 110, the torque limiter 133a prevents the impact from being transmitted to the motor 131, thereby suppressing the influence on the drive system.

A state ST263 shows a state in which the storing unit 110 is rotated to the right inclined position. Similarly, after the abutting portion 116 comes into contact with the stopper 142, the rotation direction of the storing unit 110 is switched to the reverse direction. As one example, the rotation amount of the motor 131 is controlled so that the rotation of the storing unit 110 continues until the abutting portion 116 comes into contact with the stopper 142, and then the motor 131 is stopped and rotated in the reverse direction. As the abutting portion 116 comes into contact with the stopper 142, impact is applied to the storing unit 110, and the agitation performance of the liquid in the container 200 is improved.

Note that in the rotational movement of FIG. 26, control may be performed so that impact is applied only at the inclined position on one side. Specifically, at the left inclined position, after the abutting portion 115 comes into contact with the stopper 141, the rotation direction of the storing unit 110 is switched to the reverse direction. However, at the right inclined position, the rotation direction of the storing unit 110 is switched to the reverse direction before the abutting portion 116 comes into contact with the stopper 142 so that the abutting portion 116 does not come into contact with the stopper 142.

As the opposite pattern, at the right inclined position, after the abutting portion 116 comes into contact with the stopper 142, the rotation direction of the storing unit 110 is switched to the reverse direction. However, at the left inclined position, the rotation direction of the storing unit 110 is switched to the reverse direction before the abutting portion 115 comes into contact with the stopper 141 so that the abutting portion 115 does not come into contact with the stopper 141.

In this way, when performing control so that an impact is applied only at the inclined position on one side, the combination of the abutting portion and the stopper that collide with each other may be changed under a predetermined condition. For example, when the rotational movement causing the abutting portion 115 to collide with the stopper 141 has been performed a predetermined number of times, the combination of the abutting portion and the stopper that are to collide with each other is changed to the abutting portion 116 and the stopper 142. Then, when the rotational movement causing the abutting portion 116 to collide with the stopper 142 has been performed a predetermined number of times, the combination of the abutting portion and the stopper that are to collide with each other is changed again to the abutting portion 115 and the stopper 141. Besides being based on the number of rotational movements, the condition for changing the combination may be based on the time or duration of the rotational movement.

### Second Embodiment

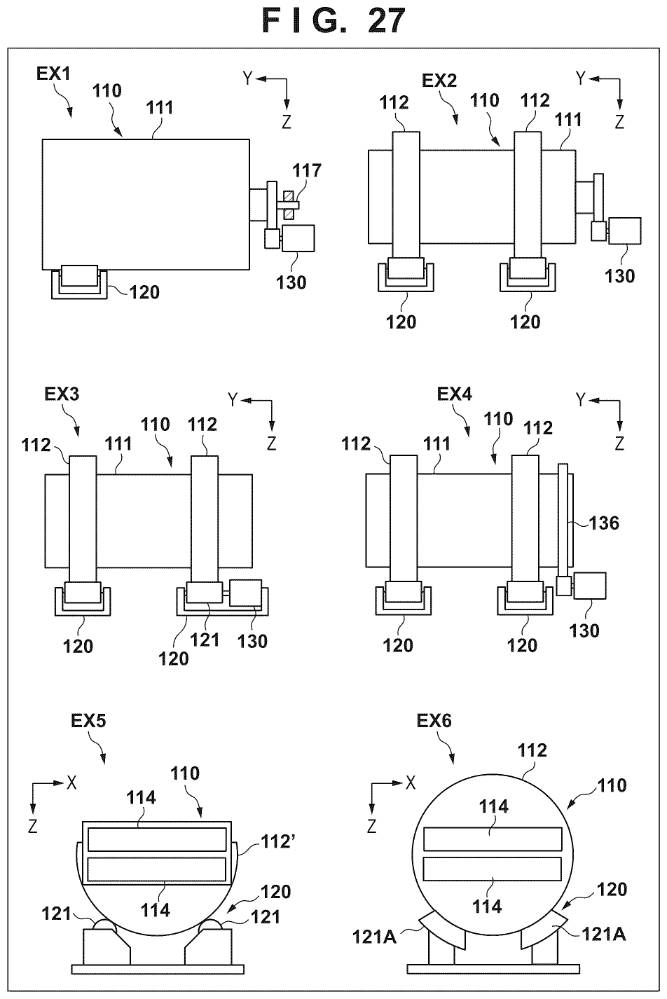

Other configuration examples of the liquid agitating apparatus 100 will be described below with reference to FIGS. 27 to 29

The storing member 111 of the first embodiment has the outer wall portion 111c that includes the cylindrical portion 112 and the rectangular tube portion 113, but as in a configuration example EX1 of FIG. 27, the entire outer wall portion of the storing member 111 may be cylindrical.

The following describes an example in which, in the first embodiment, the storing unit 110 is a rotation support structure, and the support unit 120, which is a shaftless support structure, is combined with a shafted support structure (shaft member 117, bearing member 103a). However, the storing unit 110 may be rotatably supported by only a shaftless support structure. A configuration example EX2 in FIG. 27 shows one example of this, in which two sets of a cylindrical portion 112 and a support unit 120 are provided spaced apart in the direction of the rotation center line CL to support the storing unit 110. This makes it possible to eliminate the need for the shaft member 117 and the bearing member 103a.

In the case of a configuration in which the storing unit 110 is rotatably supported by only a shaftless support structure as in this example, the drive unit 130 may be configured to rotate the abutting portions 121 (rollers) to rotate the storing unit 110, as in a configuration example EX3 of FIG. 27. Alternatively, as in a configuration example EX4 of FIG. 27, the drive unit 130 may be provided with a gear 136 fixed to the periphery of the storing member 111, and may transmit driving force to the gear 136 to rotate the storing unit 110.

Next, in the first embodiment, the cylindrical portion 112 is provided entirely circumferentially around the storing member 111, and the cylindrical portion 112 is supported by the support unit 120, but the portion that comes into contact with the support unit 120 need only extend within the rotation range of the storing unit 110. For example, as in a configuration example EX5 of FIG. 27, a circular arc-shaped portion 112′ may be provided in place of the cylindrical portion 112, and the abutting portions 121 of the support unit 120 may abut against the peripheral surface of the circular arc-shaped portion 112′.

Next, in the first embodiment, the abutting portions 121 of the support unit 120 are configured as rollers, but they may be members that slide against the storing member 111 instead of members that roll like rollers. A configuration example EX6 in FIG. 27 shows one such example. Abutting portions 121A, which replace the abutting portions 121, are each a member having a curved surface on which the cylindrical portion 112 slides instead of rolling.

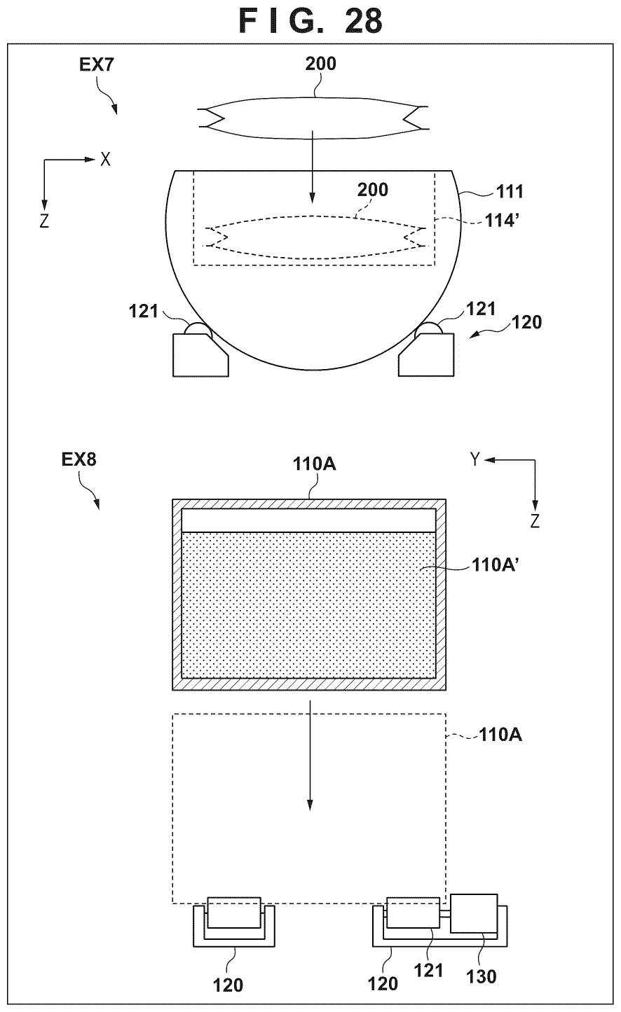

Next, in the first embodiment, the opening 114a of the storage space 114 is configured to be open at the front end portion 111a in the direction of the rotation center line CL of the storing member 111, but the opening may also be open in a direction intersecting the rotation center line CL. For example, a configuration example EX7 in FIG. 28 has a configuration in which a storage space 114′ that replaces the storage space 114 is open upward. The container 200 (or the container 200 and the container support unit 24) is inserted into and removed from the storage space 114′ in the up-down direction.

Next, in the first embodiment, the container 200 is configured to be replaceable with respect to the storing unit 110, but the storing unit 110 may be a liquid tank corresponding to the container 200. A configuration example EX8 in FIG. 28 shows one such example, in which the storing unit 110A itself constitutes a liquid tank. In this configuration example EX8, as in the configuration example EX3 of FIG. 27, only the shaftless support unit 120 is used as the support unit 120 to rotatably support the storing unit 110A. Therefore, when the remaining amount of liquid runs out, the entirety of the storing unit 110A is replaced.

The following describes an example in which, in the first embodiment, the storing unit 110 is a rotation support structure, and the support unit 120, which is a shaftless support structure, is combined with a shafted support structure (shaft member 117, bearing member 103a). However, the storing unit 110 may be rotatably supported by only a shafted support structure. A configuration example EX9 in FIG. 29 shows one such example. The storing unit 110 includes a shaft 117 at the rear end as well as a shaft 117′ at the front end, each of which is supported by a bearing 104. The bearings 104 are configured to support the shafts 117 and 117′ at horizontally extending beam portions. The beam portion and the shaft 117′ are positioned between the two storage spaces 114 at the initial position of the storing unit 110, and are configured to not significantly impede the insertion and removal of the container support unit 24 into and from the storage spaces 114.

### Third Embodiment

A third embodiment of the present invention will now be described. In the third embodiment, the configuration of the liquid storage device is different from that in the first embodiment.

The configuration and the operation of the liquid ejection apparatus 1 in the present embodiment is similar to that of the liquid ejection apparatus 1 in the first embodiment, but the configuration of the liquid storage device differs from that of the first embodiment, and therefore in the following, the description of the liquid ejection apparatus 1 will be omitted, and the description will mainly focus on the liquid storage device. Also, in the liquid storage device, configurations that perform the same functions as in the first embodiment are given the same reference numerals, and the description thereof will be partially omitted.

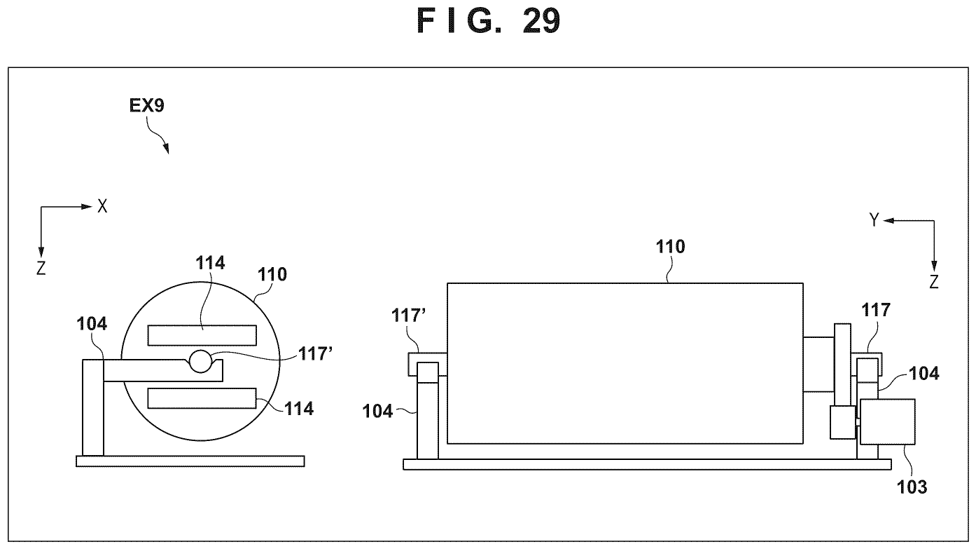

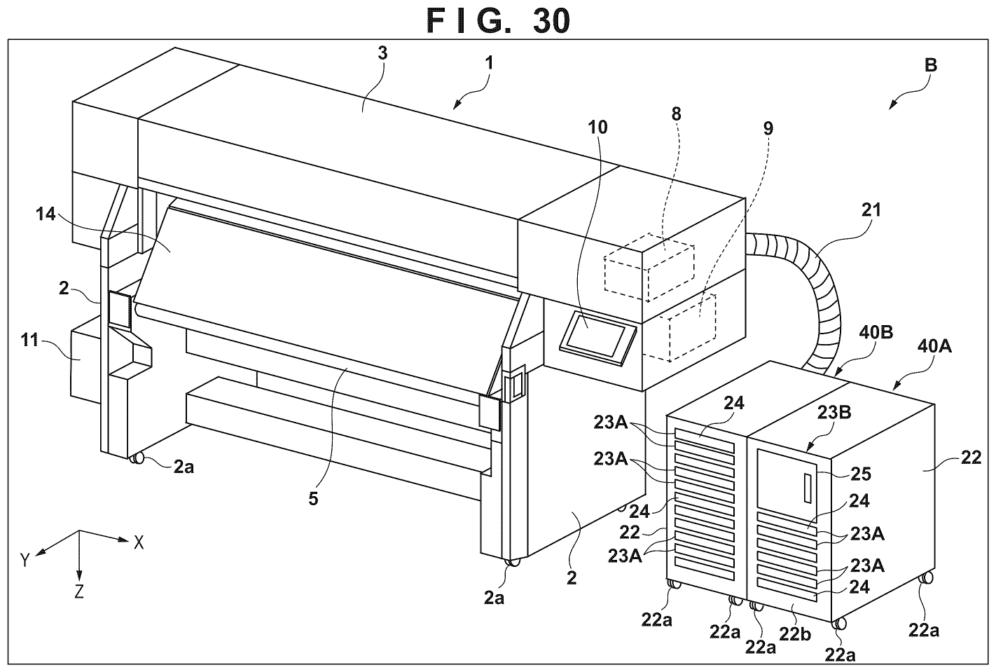

FIG. 30 is a perspective view of a system B according to the third embodiment of the present invention, and FIG. 31 is a front view of the system B. In the figures, arrows X, Y, and Z indicate directions that intersect with each other, and in the present embodiment, these directions are orthogonal to each other. When the system A is installed on a horizontal surface, the left-right direction is the X direction, the front-rear direction is the Y direction, and the up-down direction is the Z direction. The X direction and the Y direction can also be called lateral directions.

The system B of the present embodiment is a recording system that includes a liquid ejection apparatus 1 and liquid storage devices 40A and 40B, and records an image by ejecting ink onto a recording medium such as paper. In the present embodiment, two liquid storage devices 40A and 40B are provided. The liquid ejection apparatus 1 is arranged side by side with the two liquid storage devices 40A and 40B in the X direction. The liquid that the liquid storage devices 40A and 40B supply to the liquid ejection apparatus 1 is mainly ink, and the liquid ejection apparatus 1 is a recording apparatus that ejects ink onto a recording medium. However, the present invention is not limited to a recording system, and can be applied to various liquid ejection systems intended for ejecting liquid onto a medium.

The following describes characteristics of the liquid stored in the liquid storage devices 40A and 40B and the agitating performance required according to such characteristics.

As described in the first embodiment, pigment components of pigment-based inks, which have high water resistance and light resistance, and titanium oxide components used in white inks are insoluble in water and therefore settle, accumulate, and coagulate at the bottom of the container 200 due to gravity if left to stand for a long period of time. Therefore, in order to obtain a desired color, it is necessary to perform an agitating operation to disperse the color-producing components evenly in the liquid while maintaining a predetermined particle size. Therefore, it is desirable to generate movement in the liquid that exceeds the settling rate of the particles or movement that breaks up particle aggregates, thereby agitating the liquid and the color-forming components.

Incidentally, it is known that color-forming components (ink compositions) have various specific gravities and thus differ in settling rate. In other words, the faster the settling rate, the greater the movement required for agitating. As a result, if the movement is too small, the agitating will be insufficient, and if the movement is too large, the device size increases. Furthermore, as the number of colors increases and the capacity of the device increases, the number of ink containers increases.

Therefore, in the third embodiment, ink with a slow settling rate undergoes first agitation, which is an agitating operation with small movement generated by pressure, and ink with a fast settling rate undergoes a second agitation, which is an agitating operation with large movement generated by rotation.

More specifically, only ink with a fast settling rate, such as white ink, is agitated using the liquid agitating apparatus 100 built into the storage portion 23B described in the first embodiment, by changing the posture of the container 200 to agitate the ink in the container 200 (the ink in the storing means) with large movements that exchange ink up and down, thereby suppressing the settling of the ink to the bottom of the container 200. On the other hand, for inks such as normal colors that do not have a very fast settling rate, settling is suppressed by movement that does not require a large operating space for changing the shape of the container 200. A mechanism for agitating by pressing the container 200 will be described in detail later.

In the third embodiment, by arranging a plurality of agitating mechanisms in this manner, it is possible to realize optimal agitating performance according to the ink characteristics, and also to arrange ink containers at multiple levels within a limited space.

The pigment components contained in commonly used inks such as cyan, magenta, yellow, and black (hereinafter referred to as C, M, Y, and Bk) have particle sizes of several tens of nanometers and a small specific gravity, and therefore they can be agitated without applying significant movement to the container 200. Therefore, the first agitation, which involves small movement, is performed. On the other hand, titanium oxide, which is used in white ink, has a large particle size and specific gravity, and therefore is likely to settle if not subjected to significant movement. Therefore, the second agitation with large movement is performed using the liquid agitating apparatus 100 built into the storage portion 23B described in the first embodiment. Note that the liquid subjected to the second agitation by the liquid agitating apparatus 100 may be a liquid containing metal powder and having a metallic color such as gold or silver.

Here, when considering the number of ink packs (the number of containers 200) arranged in multiple levels in the liquid storage devices 40A and 40B, even when making a conservative estimate, a combination of four regular colors, three special colors, and one white color that tends to settle would require an eight-level ink supply system. There are also printing methods that use reaction liquids that promote the solidification of ink through a chemical reaction on the paper surface in order to improve the fixation and water resistance of images. Also, in order for the recovery unit, which maintains the ejection state of the recording head, to always be kept clean, a cleaning liquid may be prepared and supplied in the same manner as the ink colors. Also, two packs of the same color ink may be provided for unmanned overnight automatic operation that consumes large amounts of ink, or for stopless printing that prevents the running out of ink during printing.

In the present embodiment, there is a total of 19 bag packs (containers 200), including two packs each for six colors including normal and special colors, two packs of white ink to be placed in the liquid agitating apparatus 100, and five packs of various liquids such as a reaction liquid that reacts with the ink colors and cleaning liquid for cleaning the recovery system units. When these packs are arranged in two groups in the liquid storage devices 40A and 40B, the six normal and special colors are divided and six packs of three colors are arranged in one set in each tower (the liquid storage devices 40A and 40B). This allows for a better balance of the number of packs in each tower compared to arranging 12 packs of six colors in a single group. Also, the first agitation control is used for the inks that settle slowly, such as the regular colors and special colors, and therefore by dividing the packs such that the same number of packs is in each tower, it is possible to standardize the mechanical parts for the first agitation.

Also, the five packs of various liquids such as reaction liquid and cleaning liquid does not require agitating control due to not containing pigment components or color-forming components. Therefore, by arranging the five packs that do not require drive transmission for agitating as one set, the drive mechanism for the containers 200 that require agitating can be consolidated, thereby improving transmission efficiency. These five packs are arranged in the liquid storage device 40B. Moreover, since the white color is prone to settling, the second agitation control is used, and the liquid agitating apparatus 100 is disposed inside the storage portion 23B of the liquid storage device 40A, similarly to the first embodiment.

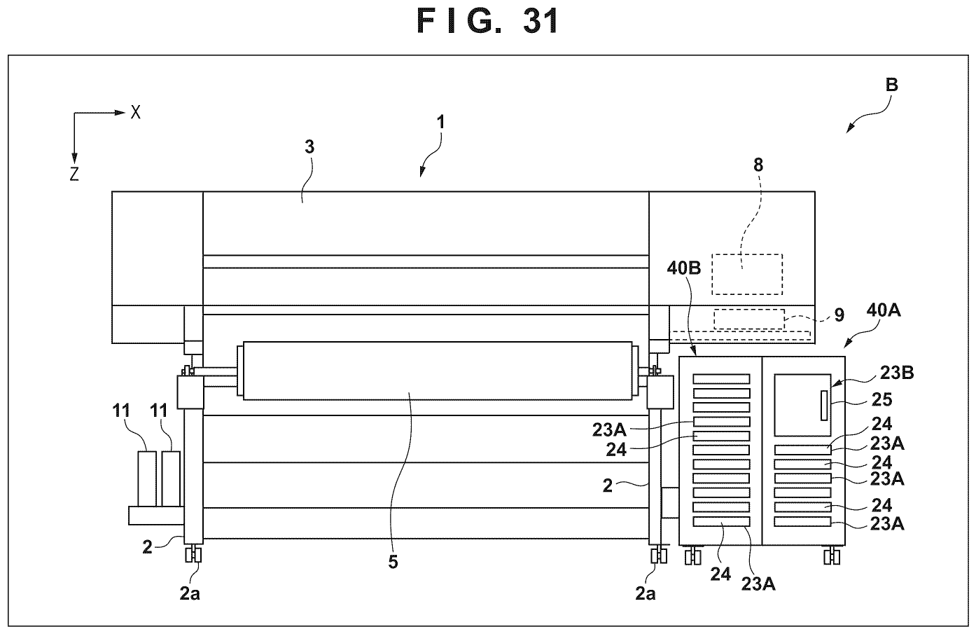

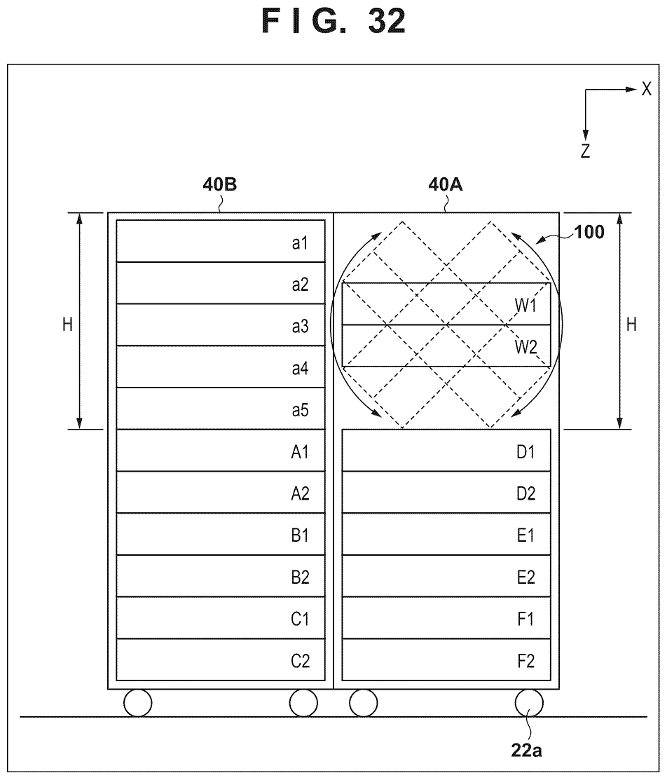

The arrangement of the containers 200 described above is shown in FIG. 32, where the normal and special colors are denoted by A to F, the white color is denoted by W, the numbers 1 and 2 are appended when there are two packs, and the reaction liquid and cleaning liquid are denoted by a1 to a5. Each of the towers (the liquid storage devices 40A and 40B) includes casters 22a so that it can be placed on the floor, and can be moved when the device is brought in or moved to a different location. Note that although the liquid storage devices 40A and 40B are connected and configured to be able to move together, they may be configured separately.

Note that in such a configuration, as shown in FIG. 32, by confining the rotational trajectory of the liquid agitating apparatus 100 to the same height H as five packs of the aforementioned containers 200 (five packs of various liquids such as the reaction liquid and cleaning liquid), the heights of the liquid storage devices 40A and 40B will be the same, which is desirable from the standpoint of space efficiency and design.

FIG. 33 is a rear view of the liquid storage devices 40A and 40B, and liquid supply units 480 for supplying ink from the containers 200 are provided. The containers 200 containing the same type of liquid share one liquid supply unit, and a switching valve (not shown) switches between the containers 200 to switch the supply of ink. Furthermore, since the containers 200 are placed below the ejection head 8, there is a height difference from the ejection head 8, and therefore the liquid supply units 480 have a pressurized supply function. Also, tubes 21a are respectively connected to the liquid supply units 480, and are bundled and routed inside a hose 21 that is bendable on the rear side. The tubes in the hose 21 supply ink of the various colors and the reaction liquid to the ejection head 8, and supply the cleaning liquid to the recovery unit.

In FIG. 31, the height of the liquid storage devices 40A and 40B of the present embodiment is set lower than the lower surface of the main body 3 that protrudes toward the +X side of the liquid ejection apparatus 1. Therefore, the liquid storage devices 40A and 40B can be stored under the main body 3 as shown in FIG. 31. The liquid storage devices 40A and 40B can be moved in the X direction to a position at which they come into contact with the stand 2.

The case where the liquid storage devices 40A and 40B are disposed in the space below the main body 3 will be further described below with reference to FIGS. 30 to 33. In FIG. 33, the hose 21 bundling the tubes 21a connected to the liquid storage devices 40A and 40B is connected to the liquid ejection apparatus 1 on the rear side. Furthermore, since the liquid storage devices 40A and 40B includes the casters 22a, they can be moved and installed so as to be close to the liquid ejection apparatus 1.

In FIG. 31, the liquid storage devices 40A and 40B are installed so as to occupy the space below the main body 3. Also, since the operation panel is installed directly above the main body 3, it is possible to replace the containers 200 while looking at the information on the panel, and this provides excellent operability.

Moreover, the white ink container 200, on which the second agitation is performed, includes the opening/closing member 25 to prevent being operated during rotation for agitating. The white ink container 200 is different from the containers 200 for the other colors in that it requires the opening/closing member 25 to be opened, and is therefore arranged at the top in consideration of operability. Furthermore, the longer the vertical flow passage of the ink is, the more likely it is that sediment will accumulate in the lower part of the tube due to gravity. Therefore, for the white ink which is prone to settling, it is desirable to place it at the top level where the vertical flow passage from the container 200 to the main body 3 is the shortest. Moreover, it is known that white ink generally has a high viscosity. Therefore, in consideration of flow passage resistance, it is desirable that the white ink container 200 is placed at the top level where the height difference (head difference) from the ejection head 8 is small. Furthermore, if white ink is not used, the device can be completed simply by removing the white ink from the top, making it highly versatile.

Moreover, the liquid storage devices 40A and 40B are connected to the liquid ejection apparatus 1 by a connecting member. This is to prevent the liquid storage devices 40A and 40B from being inadvertently moved, which may damage the tubes 21a in the hose 21.

In the present embodiment, the liquid storage devices 40A and 40B making up two towers have been described, but a one-tower liquid storage device including a first agitation mechanism and a second agitation mechanism may also be adopted. Also, a configuration is possible in which only the second agitation mechanism is disposed below the recovery unit 9, and the first agitation mechanism, which does not require a large height, is arranged below the roll paper. Furthermore, the waste liquid cartridge 11 and the liquid storage devices 40A and 40B may be arranged so as to be interchangeable in position.

Next, a mechanism for first agitation in the liquid storage devices 40A and 40B will be described. Note that the mechanism for second agitation is the same as that of the liquid agitating apparatus 100 described in the first embodiment.

### Mechanism for First Agitation

### Liquid Container and Support Unit

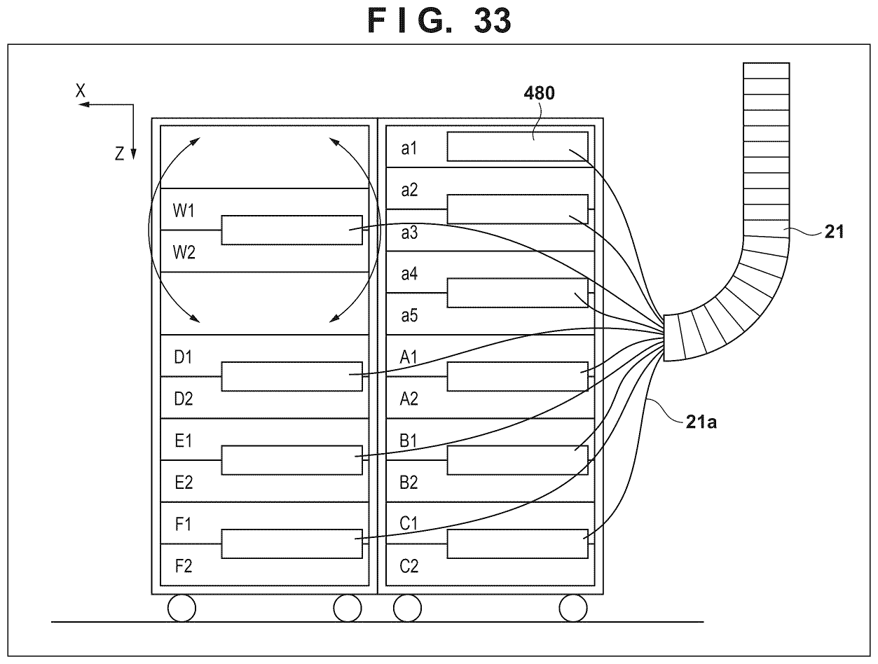

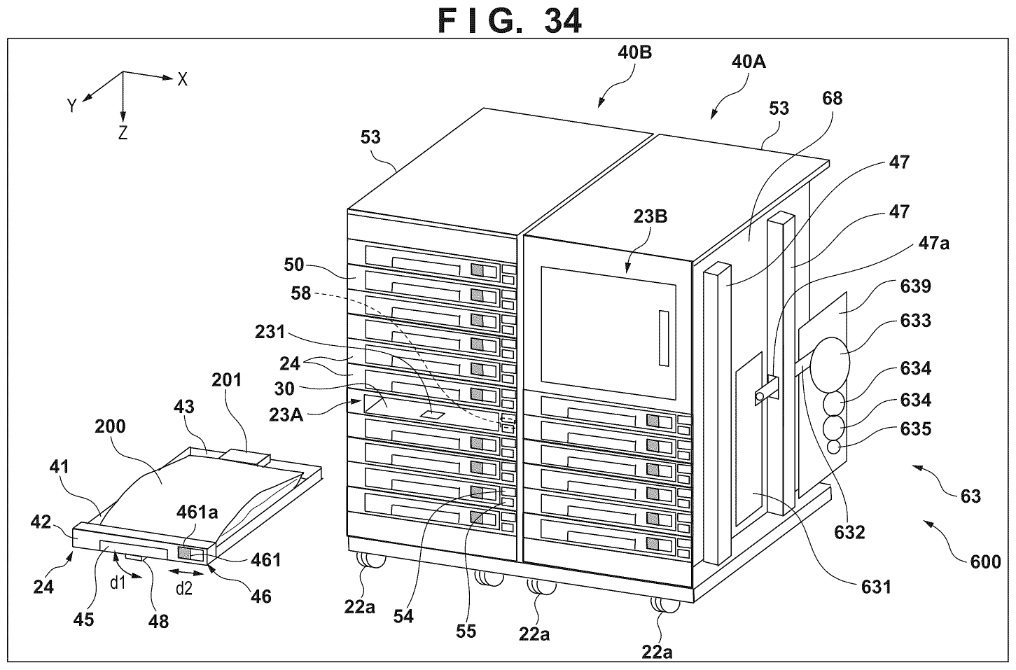

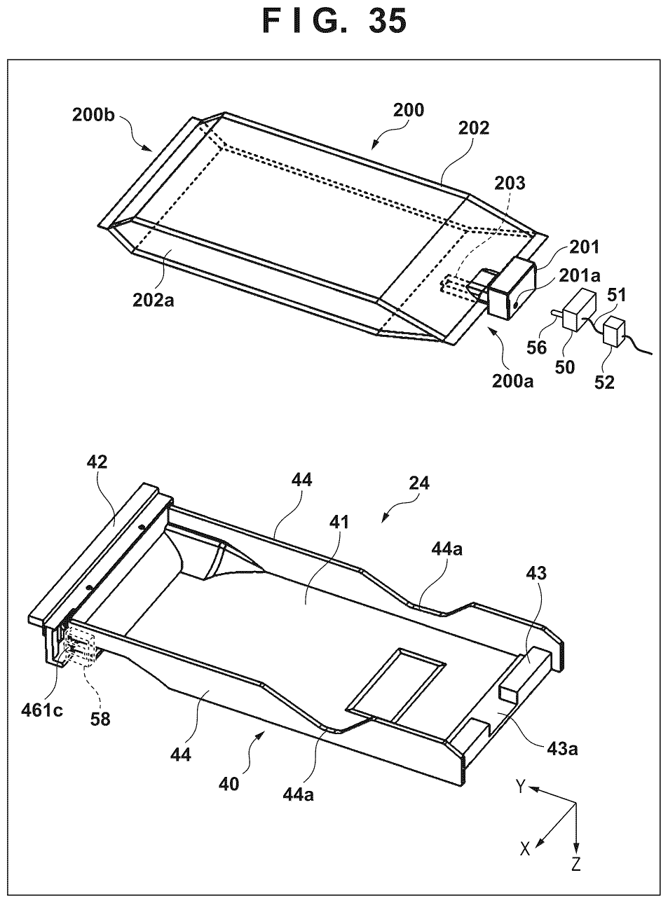

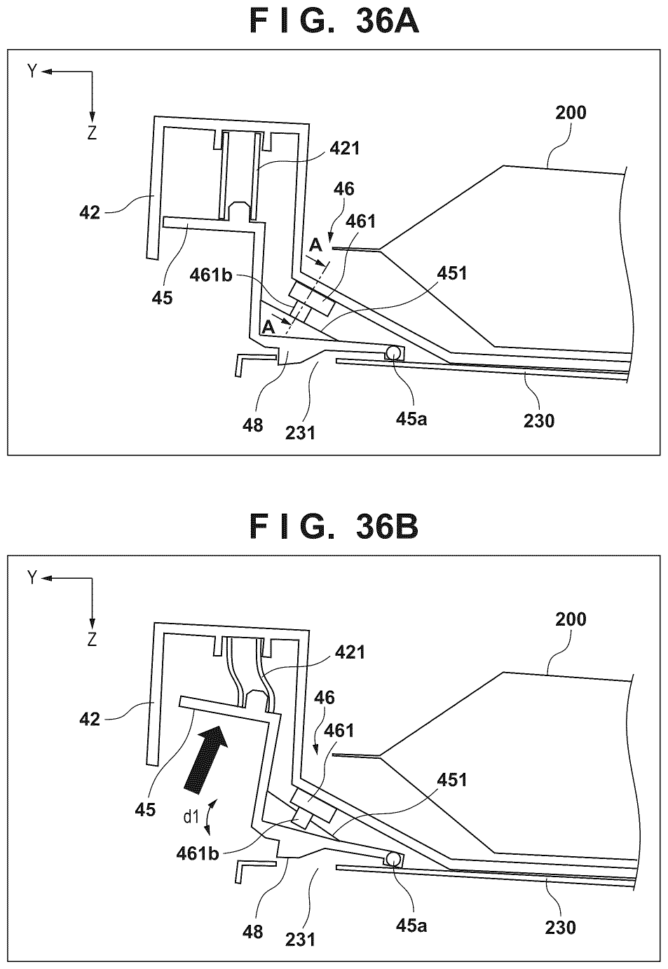

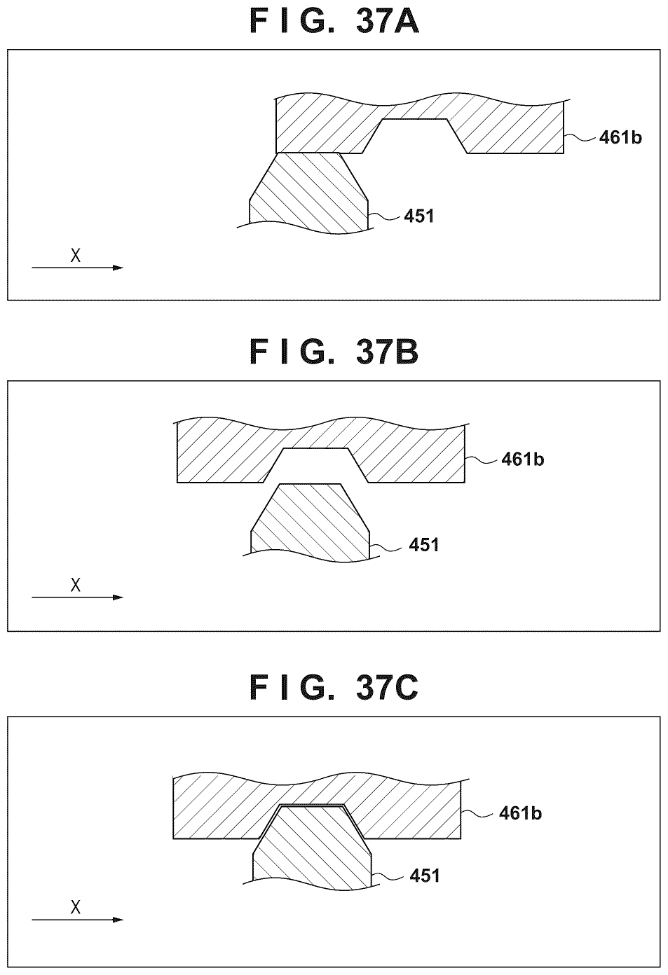

FIGS. 34 to 37C will be referred to below. FIG. 34 is a partially exploded perspective view of the liquid storage devices 40A and 40B, showing a state where one container support unit 24 has been removed from the corresponding storage portion 23A. FIG. 34 shows the liquid storage devices 40A and 40B with some of the outer side wall portions removed to expose the internal mechanism. FIG. 35 is a perspective view of one container 200 and one container support unit 24. FIGS. 36A and 36B are illustrative diagrams of operation of a handle 45 and a lock mechanism 46. FIGS. 37A to 37C are illustrative diagrams for describing operation of the lock mechanism 46, and correspond to cross-sectional views taken along a line A-A in FIG. 36A.

The container 200 has a bag 202 formed from a flexible material. The two sides of the bag 202 are provided with gusset portions 202a folded inward to increase the amount of liquid that can be contained. The bag 202 is formed into a bag shape by welding together the sheets constituting the top and bottom surfaces and the sheets forming the gusset portions 202a, thereby forming a flexible tank for storing a liquid. As the amount of liquid inside increases, the gusset portions 202a expand, and as the amount of liquid inside decreases, the gusset portions 202a fold inward, and in this way, the shape of the bag 202 changes according to the amount of liquid contained therein. The material constituting the bag 202 is, for example, a material having a multi-layer structure such as PET. If there is concern that the liquid inside may react with air and solidify, or that the concentration or remaining amount may change due to evaporation, a layer material containing an aluminum layer can be advantageously used as the material for the bag 202.

The container 200 has one end portion 200a and another end portion 200b in the longitudinal direction. When mounted to the liquid storage device 40A or 40B, the end portion 200a is located on the rear side of the liquid storage device 40A or 40B, and the end portion 200b is located on the front side. An outlet member 201 is provided at the end portion 200a. The outlet member 201 has a supply port 201a that is in communication with an intake port 203 inside the bag 202. The liquid contained in the bag 202 flows out through the intake port 203 and the supply port 201a. A spring-loaded supply port opening/closing valve for opening and closing the supply port 201a is provided inside the outlet member 201. The supply port 201a is normally kept in the closed state by the supply port opening/closing valve.

The side of the container 200 on which the outlet member 201 is provided has a length of, for example, about 180 mm, and the sides orthogonal thereto (side surfaces) have a length of, for example, about 400 mm. The container 200 contains, for example, about 1.5 L of liquid. Note that the side on which the outlet member 201 is located may be the long side instead of the short side. Additionally, the bag 202 may be square rather than rectangular in a plan view.

The main body 53 of the liquid storage devices 40A and 40B includes a needle-type flow passage forming member 56, which is for insertion into the supply port 201a, on the rear side of the storage portion 23A. The flow passage forming member 56 is provided for each storage portion 23A. When the flow passage forming member 56 is inserted into and connected to the supply port 201a, the supply port opening/closing valve is set to the open state by the insertion of the flow passage forming member 56. The flow passage forming member 56 is supported by a block-shaped support member 50 and is connected to a tube 51. The flow passage forming member 56 forms a flow passage that allows the liquid contained in the bag 202 to flow out to the liquid ejection apparatus 1, which is the destination, and the liquid that flows out to the flow passage forming member 56 is supplied to the liquid ejection apparatus 1 via the tube 51. An electrically operated flow passage valve 52 is provided at an intermediate portion of the tube 51. The tube 51 can be blocked and opened by opening and closing the flow passage valve 52.

The container support unit 24 has a support portion 40 for supporting the container 200, and has the overall form of a tray on which the container 200 is placed in a lying posture. The container support unit 24 is displaceable in approximately the Y direction between a storage position, at which the container 200 is stored in the main body 53, and a removed position, at which the container 200 is exposed to the outside of the main body 53. In FIG. 34, one container support unit 24 is located at the removed position, and the other container support units 24 are all located at the storage position. At the removed position, the container 200 can be replaced, and at the storage position, the liquid contained in the container 200 can be supplied to the liquid ejection apparatus 1. In the present embodiment, the container support unit 24 is separated from the storage portion 23A at the removed position. However, the removed position may be a position at which an end of the container support unit 24 is held in the storage portion 23A, and may be any position at which the container 200 can be replaced in the container support unit 24.

The support portion 40 has a placement surface 41 on which the container 200 is placed, and the four sides of the placement surface 41 are defined by left and right side plates 44, a front end portion 42, and a rear end portion 43. The side plates 44 each have a notch 44a formed therein. The rear end portion 43 is provided with a recess 43a in which the outlet member 201 is disposed.

A handle 45 that is rotatable about a shaft 45a extending in the X direction is provided at the front end portion 42, and the user can rotate the handle 45 in a direction d1. The handle 45 also serves as an operation handle for an engagement portion 48. The engagement portion 48 is provided on the handle 45, and an engagement portion 231 that engages with the engagement portion 48 is formed on the bottom of the case 230 that forms the storage portion 23A. In the present embodiment, the engagement portion 48 is a protrusion, and the engagement portion 231 is a recession into which the engagement portion 48 is inserted. By engaging the engagement portion 48 with the engagement portion 231, the container support unit 24, which has been mounted to the storage portion 23A and positioned in the storage position, can be prevented from coming out of the storage portion 23A even if vibration occurs due to, for example, movement of the liquid storage devices 40A and 40B. The handle 45 is constantly biased by an elastic member 421 toward an engaged position where the engagement portion 48 and the engagement portion 231 are engaged with each other (position in FIG. 36A). The elastic member 421 is, for example, a coil spring. When the user grasps the handle 45 and rotates the handle 45 in the direction indicated by the arrow in FIG. 36B, the engagement portion 48 and the engagement portion 231 become disengaged, and the container support unit 24 inside the storage portion 23A can be removed from the storage portion 23A.

To prevent the container support unit 24 mounted to the storage portion 23A from being inadvertently removed, a lock mechanism 46 for locking the container support unit 24 in the stored position is provided for each storage portion 23A (see FIG. 34). The lock mechanism 46 includes a slide member 461 built into the front end portion 42. An operation portion 461a, which is a part of the slide member 461, is exposed from the front end portion 42 so as to be operable by the user. The slide member 461 is can move in the direction of an arrow d2 (X direction) between a locked position that restricts the rotation of the handle 45 in the direction d1 and an unlocked position that allows the handle 45 to rotate.

FIGS. 36A and 37A show the slide member 461 at the locked position. In other words, the lock mechanism 46 is in the locked state. The slide member 461 has an abutting portion 461b, and the abutting portion 461b comes into contact with an abutting portion 451 provided as a rib on the handle 45. In FIGS. 36A and 37A, the slide member 461 obstructs the handle 45 from being rotated in the disengagement direction. Therefore, the container support unit 24 cannot be removed from the storage portion 23A.

FIG. 37B shows the slide member 461 at the unlocked position. In other words, the lock mechanism 46 is in the unlocked state. A notch of the abutting portion 461b and the abutting portion 451 face each other. At this time, since the abutting portion 451 can escape into the notch of the abutting portion 461b as shown in FIG. 37C, the handle 45 can be rotated in the disengagement direction as shown in FIG. 36B. In this way, the user can slide the slide member 461 to the unlocked position and then operate the handle 45, and thus pull out the container support unit 24 from the storage portion 23A.

The storage portion 23A includes a sensor 58 that detects the position of the slide member 461 (see FIGS. 34 and 35). The sensor 58 is, for example, an optical sensor (e.g., a photointerrupter) capable of detecting a detection piece 461c of the slide member 461. When the slide member 461 is at the locked position, the detection piece 461c is located at a detection position of the sensor 58 as shown in FIG. 35, and is detected by the sensor 58. When the slide member 461 is at the unlocked position, the detection piece 461c is not positioned at the detection position of the sensor 58, and is not detected by the sensor 58. In this way, based on the detection result of the sensor 58, it is possible to determine whether the position of the slide member 461 is at the locked position or the unlocked position, that is, whether the lock mechanism 46 is in the locked state or the unlocked state.

The opening and closing of the flow passage valve 52 can be linked with the detection result of the sensor 58. For example, when the flow passage valve 52 is in the open state, if the sensor 58 detects that the slide member 461 is at the unlocked position, the flow passage valve 52 is immediately closed in response to the detection. This makes it possible to prevent the container support unit 24 from being pulled out of the storage portion 23A while the flow passage valve 52 is open. If the container support unit 24 is pulled out from the storage portion 23A while the flow passage valve 52 is in open state, air may enter the tube 51 through the flow passage forming member 56. This can cause problems such as solidification of the liquid inside the tube 51 and poor ejection from the ejection head 8. When it is detected that the slide member 461 is at the unlocked position, the flow passage valve 52 is immediately closed by automatic control in conjunction with the detection, thereby preventing air from entering the tube 51.

### Slot Inclination

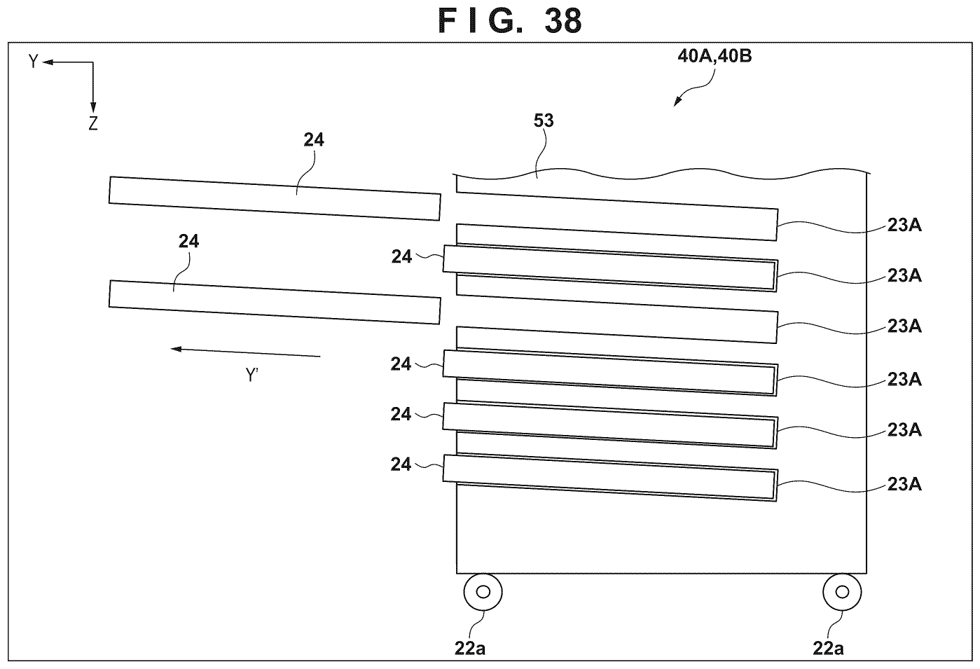

FIG. 38 is a diagram showing the portion below storage portion 23B of the liquid storage devices 40A and 40B, illustrating the mounting posture and insertion/removal of the container support units 24 in the storage portions 23A.

As shown in FIG. 38, the storage portions 23A provided at the various levels in the liquid storage devices 40A and 40B are inclined so as to be lower (+Z direction) while extending rearward (toward the back, −Y direction). Therefore, the container support unit 24 is held in an inclined posture when mounted. Although the effect of this will be described later, the inclination angle is, for example, less than 45 degrees relative to the horizontal plane, and particularly 10 degrees or less. In the example of FIG. 38, the inclination angle is assumed to be 3 degrees.

### Liquid Agitating Mechanism

The container 200 can contain various types of liquid and can be used for image recording, maintenance of the ejection head 8, and the like. For example, the container 200 can contain water-based ink, latex ink, eco-solvent, or another solvent-based ink. Depending on the type of ink, the coloring material (e.g., pigment components) in the ink may settle over time. The ink colors may each have a coloring material of a different particle size, and different types and amounts of additives, and the settling rate may differ depending on the ink color. The container 200 can also contain a reaction liquid that is ejected from the ejection head 8 and reacts with the ink to fix the ink on the surface of the recording medium M. In the case where the container 200 contains a liquid whose components tend to separate, the uniformity can be improved by appropriately agitating the contained liquid. This contributes to preventing degradation of the quality of the recorded image, for example.

In the present embodiment, the bag 202 of the container 200 is deformed by being physically pressed from the outside. This causes the contained liquid to flow and agitate within the bag 202. Depending on the type of liquid contained in the container 200, there may be types that do not require agitating. Therefore, in the present embodiment, a storage portion 23A provided with an agitation function and a storage portion 23A without the agitation function are provided. Specifically, the upper storage portions 23A (for five packs of various liquids such as a reaction liquid and a cleaning liquid) are not provided with the agitation function, whereas the middle and lower storage portions 23A include the agitation function. Of course, all of the storage portions 23A may be provided with the agitation function.

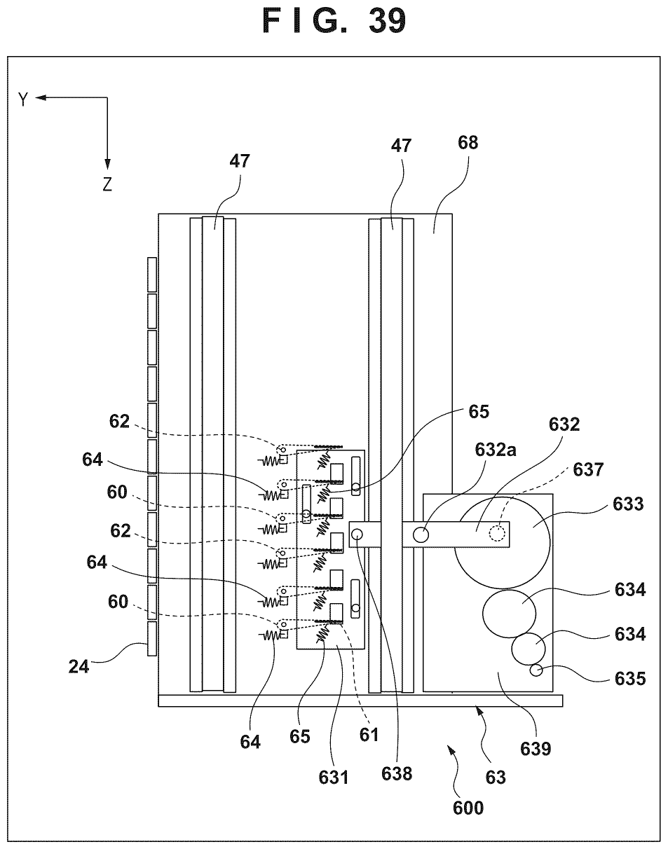

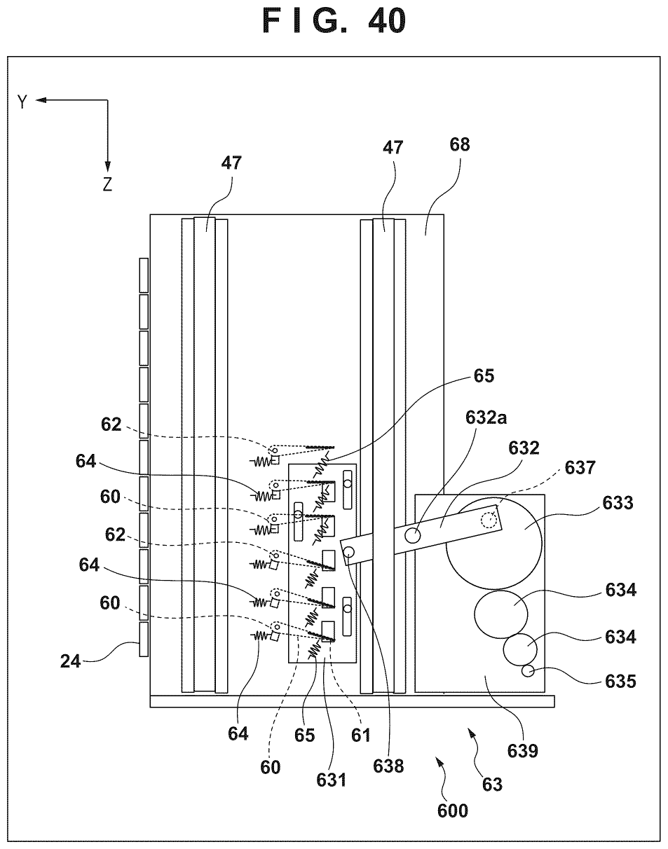

The configuration of a pressing unit 600 that realizes the agitation function will be described below with reference to FIGS. 34, 39 and 40. FIGS. 39 and 40 are illustrative diagrams of operation of the pressing unit 600 when the main body 53 is viewed from the side. The pressing unit 600 includes a plurality of pressing members 60 and one moving mechanism 63 common to the pressing members 60. One pressing member 60 is provided for each of the storage portions 23A, and is an agitating portion for agitating the liquid in the corresponding container 200. The moving mechanism 63 is a drive unit that drives the pressing members 60. In the present embodiment, one pressing member 60 is provided for each of the storage portions 23A. The moving mechanism 63 rotates the pressing members 60 synchronously around rotation shafts 62, and thus pressing portions 61 provided on the pressing members 60 press the containers 200 from above and also relieve the pressure. FIG. 39 shows the pressing portions 61 (and the pressing members 60) at a pressure-releasing position, and FIG. 40 shows the pressing portions 61 (and the pressing members 60) at a pressure-applying position.

The configuration of the moving mechanism 63 will be described below. The output of a motor 635, which is the drive source of the moving mechanism 63, is transmitted to a cam 633 via a plurality of gears 634. Note that the rotation axis of each of these components is in the X direction. Here, the configuration of the cam 633 will be described below with reference to FIGS. 41A and 41B. FIGS. 41A and 41B are illustrative diagrams of the cam 633, and FIG. 41B shows a state in which the cam 633 has been rotated 180 degrees from the state shown in FIG. 41A.

The cam 633 is a disk-shaped member that can rotate around a shaft 633b extending in the X direction, and has a gear teeth portion 633a formed on the outer peripheral surface. The gear teeth portion 633a meshes with the gear 634, and the rotation of the gear 634 causes the cam 633 to rotate. A groove 633c is formed in the side surface of the cam 633, and the outer and inner side surfaces of the groove 633c form an outer cam surface 633d and an inner cam surface 633e. A cam follower 637 connected to a drive transmission lever 632 is disposed in the groove 633c. The inner cam surface 633e is located inward of the cam follower 637 in the radial direction of the cam 633, and when the cam 633 rotates, the inner cam surface 633e comes into contact with the cam follower 637 and acts to lift the cam follower 637. Furthermore, the outer cam surface 633d is located outward of the cam follower 637 in the radial direction of the cam 633, and when the cam 633 rotates, the outer cam surface 633d comes into contact with the cam follower 637 and acts to pull the cam follower 637 down.

FIGS. 34, 39 and 40 will be referred to below. When the cam follower 637 moves up and down due to the rotation of the cam 633, the drive transmission lever 632 rotates around the rotation shaft 632a. The drive transmission lever 632 is rotatably connected to a shaft portion 638 provided on a lifting member 631, the movement of the drive transmission lever 632 is converted into the lifting and lowering of the lifting member 631. When the cam 633 makes one full rotation, the cam follower 637 performs one reciprocating motion in the Z direction, and the lifting member 631 similarly performs one reciprocating lifting motion via the drive transmission lever 632.

The plate-shaped lifting member 631 is attached to the side plate 68 of the main body 53 so as to be movable up and down in the Z direction. Furthermore, two pillars 47, which are U-shaped in cross section and extend in the Z direction, are fixed to the side plate 68 at the front and rear, respectively. Pillars 47 are also attached to the side plate on the −X side, and the main body 53 has a total of four pillars 47 to ensure the structural strength. This makes it possible to support the weight of a large number of containers 200.

Although the pillars 47 are strong, they are also thick, and therefore if the moving mechanism 63 is provided further outward in the X direction from the pillars 47 attached to the side plates 68, the dimension in the X direction will become large. For this reason, in the present embodiment, the driving mechanisms such as the lifting member 631 and the cam 633 are separated from each other in the Y direction to the front and rear of one of the pillars 47 as a boundary. The drive transmission lever 632 is inserted through a through hole 47a provided in one of the pillars 47.

In this way, the strength can be ensured and the moving mechanism 63 of the pressing unit 600 can be disposed while suppressing an increase in the size of the main body 53 in the X direction. Furthermore, the drive transmission lever 632 is attached to a plate-shaped support member 639 that supports the moving mechanism 63. By removing fixing elements such as fastening screws, most of the configuration of the moving mechanism 63 can be removed as an integrated unit together with the support member 639 to the rear side of the main body 53. Therefore, parts replacement and the like can be easily performed by a service technician. Note that if the fastening screws or other fixing elements are fastened from the rear side of the main body 53, fastening and unfastening can be performed easily.

Each of the pressing members 60 is subjected to a biasing force by two springs 64 and 65. One end of the spring 64 is attached to the pressing member 60, and the other end is attached to the storage portion 23A (case 230). Moreover, one end of the spring 65 is attached to the pressing member 60 and the other end is attached to the lifting member 631. The pressing member 60 is a movable member (particularly a rotating member) that is attached to the storage portion 23A (case 230) so as to be rotatable about rotation shafts 62 as the rotation center. The rotation shafts 62 extend along an axis that intersects the moving direction (Z direction) of the pressing portion 61. The two springs 64 and 65 both bias the pressing member 60 in a direction of rotating clockwise as viewed in FIGS. 39 and 40.

When the pressing member 60 is in the pressure-releasing position (FIG. 39), the lifting member 631 is in contact with and lifts up the pressing member 60, and therefore the biasing force of the spring 65 acts between the lifting member 631 and the pressing member 60. Therefore, the biasing force of the spring 65 acts only between the lifting member 631 and the pressing member 60, and does not apply a load to the motor 635. In other words, the load acting on the moving mechanism 63 in the pressure-releasing position is only the biasing force of the spring 64 and the weight of the components.

When the pressing member 60 is in the pressure-applying position (FIG. 40), the cam 633 is in a phase opposite to the pressure-releasing position by 180 degrees, and the pressing portion 61 of the pressing member 60 comes into contact with and presses down the container 200. The pressing distance of the pressing portion 61, that is to say the rotation amount of the pressing member 60, varies depending on the remaining amount of liquid in the container 200. In FIG. 40, the pressing members 60 in the top three levels are shown pressing a full container 200, whereas the pressing members 60 in the bottom three levels are shown pressing a low-volume container 200 with almost no liquid remaining. The biasing forces of both the spring 64 and the spring 65 and the weight of the components act on the container 200. Since the springs 64 and 65 are disposed in each of the storage portions 23A, an optimal pressing force can be applied to each storage container 200 even if the remaining amount of liquid in the container 200 in each storage portion 23A differs.

At this time, the biasing force of the spring 64 acts on the container 200 and does not act on the lifting member 631. The biasing force of the spring 65 acts between the container 200 and the lifting member 631 which are in contact with each other via the pressing member 60. The cam 633 acts to pull the lifting member 631 downward from the container 200. In this way, the load applied to the moving mechanism 63 during operation is reduced by using the two springs 64 and 65 attached at different positions and the cam 633 that can move both upward and downward.

Also, at the pressure-applying position, when the remaining amount of liquid in the container 200 is small and the volume of the container 200 is low, the spring 64 and the spring 65 are stretched less, and therefore the pressing force acting on the container 200 is also smaller. When the remaining amount of liquid in the container 200 is large, a reaction force is likely to be received from the container 200 during pressing, and a larger pressing force is required to press deeply. Conversely, when the remaining amount of liquid is small, the reaction force from the container 200 is small, and therefore even a small pressing force can easily deform the container 200 and move the liquid inside. Therefore, the spring 64 and the spring 65 are disposed at positions where the pressing force decreases as the volume of the container 200 decreases. This eliminates the need to make the biasing force of the springs greater than necessary. In the present embodiment, the load applied to the pressing portion 61 is adjusted to be, for example, about 500 gf when the container 200 is full, and about 300 gf when there is almost no remaining amount of liquid.

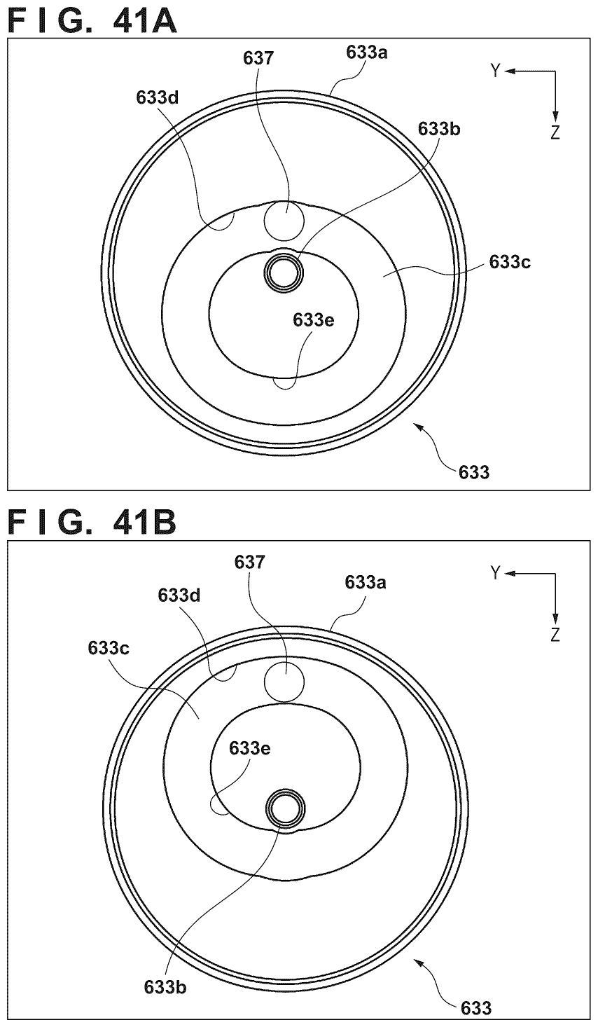

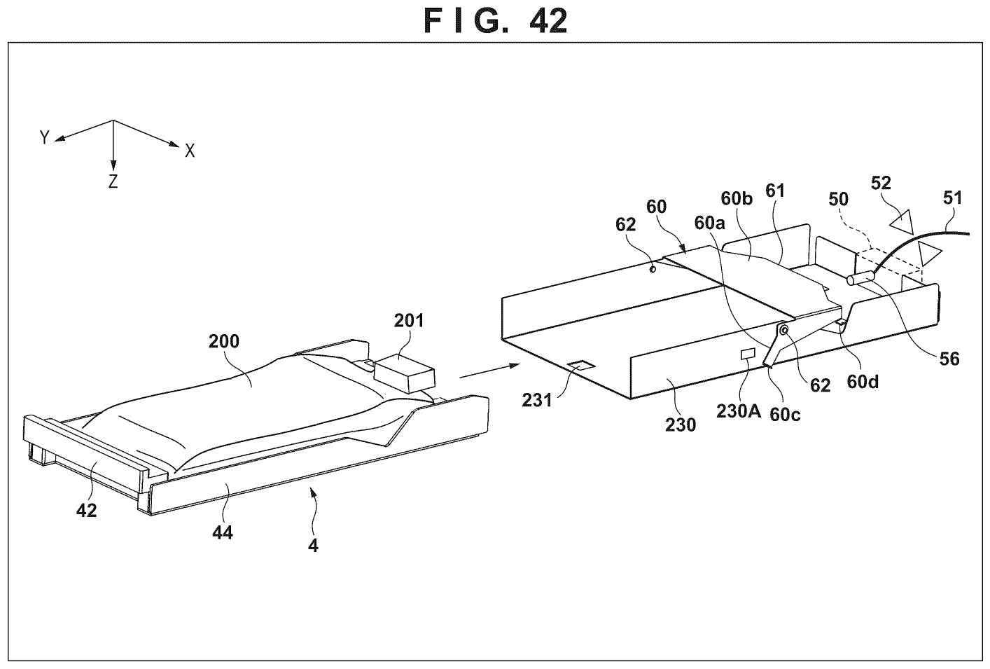

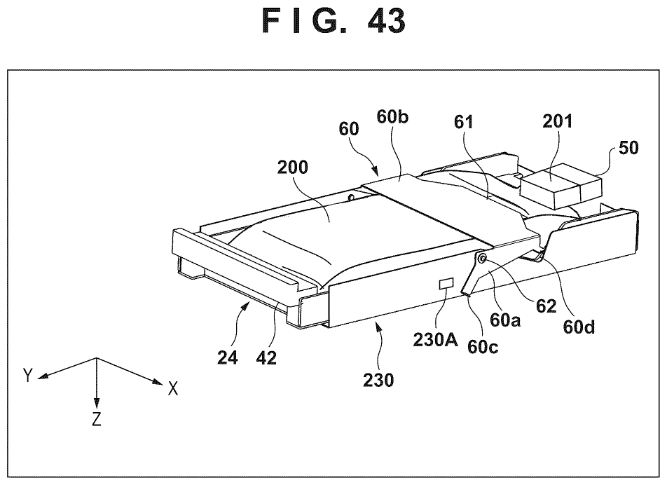

The configuration of the pressing member 60 will be described below with reference to FIGS. 42 and 43. FIG. 42 is a perspective view of a case with the agitation function and the support unit in a separated state, and FIG. 43 is a perspective view of the case with the agitation function and the support unit in a mounted state.

The pressing member 60 has a pair of side plates 60a located on opposite sides of the case 230 in the X direction, and a top plate 60b that connects the pair of side plates 60a so as to extend across the case 230 in the X direction. The pressing member 60 is rotatably supported by the side plates 60a of the case 230 via rotation shafts 62, and the pressing portion 61 is formed at the leading end of the top plate 60b.

Each of the side plates 60a is provided with a locking portion 60c to which the end of the spring 64 is locked, and an abutting portion 60d to which the end of the spring 65 is locked and which abuts against the lifting member 631 when the lifting member 631 is raised, thus causing the pressing member 60 to rotate. The locking portion 60c and the abutting portion 60d are both formed in the form of a protruding piece protruding in the X direction.

A remaining amount detection sensor 230A is provided on one side of the case 230. The remaining amount detection sensor 230A is, for example, an optical sensor. The remaining amount detection sensor 230A is a position detection sensor that detects the side plate 60a to detect the position of the pressing portion 61, and also detects the remaining amount of the container 200 based on the position detection result. Specifically, the detection position of the remaining amount detection sensor 230A is arranged at a position at which the sensor can detect the side plate 60a when the container 200 that has decreased in volume due to a decrease in the remaining amount is pressed. This utilizes the fact that the amount of pressure applied when pressing changes depending on the degree to which the container 200 has decreased in volume. In the present embodiment, since the pressing portion 61 is brought into contact with the container 200, the position of the side plate 60a reflects the remaining amount of liquid in the container 200, and therefore the remaining amount detection accuracy is high. The detection position of the remaining amount detection sensor 230A is designed such that the side plate 60a is detected when the container 200 with a remaining amount of about 100 ml is pressed.

The pressing member 60 can be made of, for example, a metal plate (e.g., a steel plate). Due to being thin yet strong compared to materials such as resin, the height of the storage portion 23A can be reduced. The rotation shafts 62 of the pressing member 60 re disposed outward of the container 200 in the X direction, and are provided at positions at which the rotation shafts 62 and the container 200 overlap in the X direction when the container 200 is full. By taking these measures to reduce the size in the Z direction, even if the pressing member 60 is installed in the storage portion 23A in each level to provide the agitation function, multiple levels of containers 200 can be stored in the limited space under the housing of the system B.

Also, the width of the pressing member 60 in the X direction is shorter at the pressing portion 61 than in the vicinity of the rotation shafts 62. This prevents any portion other than the pressing portion 61 from coming into contact with the container 200 when the pressing portion 61 presses the tank, and prevents the container 200 from becoming damaged.

Making the width of the pressing member 60 in the X direction shorter at the pressing portion 61 than in the vicinity of the rotation shafts 62 has advantages such as the following. As described above, the container 200 has the gusset portions 202a on the two sides. The gusset portions 202a include a welded portion between flexible members and have a higher rigidity than other portions. In order to cause the container 200 to decrease in volume by causing the gusset portions 202a to fold inward in response to a decrease in the remaining amount of liquid, a suitable pressing force is required. When the remaining amount of liquid in the container 200 is large, the gusset portions 202a are spread out in the up-down direction, and there are cases where the gusset portions 202a bulge outward instead of inward. In order to squash the gusset portions 202a, a suitable pressing force is required.

By arranging the pressing portion 61 inward of the gusset portions 202a in the X direction, the container 200 can be efficiently pressed and deformed for agitating. Specifically, the pressing portion 61 is disposed so as to press the central region of the container 200 rather than toward the gusset portions 202a, and the most expanded portion of the container 200 is pressed. The height of the gusset portions 202a on the two sides is, for example, about 20 mm, and since the pressing portion 61 is located inward of the gusset portions 202a on the two sides, it is less susceptible to the reaction force of the gusset portions 202a and can press the container 200 efficiently. More efficient pressing can be achieved by designing the width of the pressing portion 61 in the X direction to a size that falls within, for example, 10 mm or more inward of the gusset portions 202a. This is because the influence of the reaction force of the gusset portions 202a becomes smaller the farther the pressing portion 61 is separated from the gusset portions 202a in the X direction.

In order to minimize the width of the pressing portion 61 in the X direction, for example, the pressing portion 61 may be shaped to come into contact with the container 200 at one point. However, in the case where the container 200 is elongated in the Y direction as in the present embodiment, if the pressing portion 61 is shaped to come into contact with the container 200 at one point, fluid movement of the liquid inside the container 200 may decrease. Specifically, if the width of the pressing portion 61 in the X direction is too small, the flow of pushed liquid in the pressed container 200 will also be dispersed outward in the X direction, and the amount of liquid flowing in the Y direction will decrease accordingly.

Therefore, for example, if the width of the pressing portion 61 in the X direction is set to be at least one-third the width of the bag 202 of the container 200 in the X direction, the fluid movement of the liquid in the Y direction within the bag 202 when pressed can be improved. For example, if the width of bag 202 in the X direction is 180 mm, the width of the pressing portion 61 in the X direction can be set to 60 mm or more to improve the fluid movement of the liquid in bag 202 in the Y direction when pressed.

In summary, when the bag 202 has a width in the X direction of 180 mm and the gusset portions 202a have a height of 20 mm, the width in the X direction of the pressing portion 61 is suitably between 60 mm and 120 mm, and may in particular be 90 mm.

### Agitating Operation

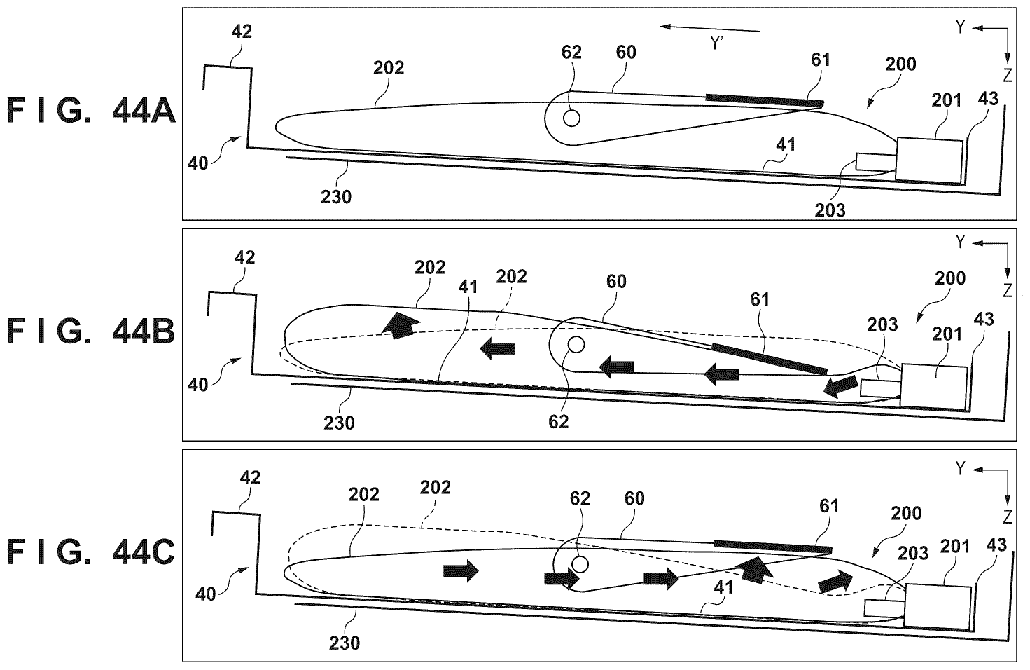

The agitating of the liquid in the container 200 caused by the pressing portion 61 pressing against the container 200 will be described below with reference to FIGS. 44A to 44C. FIGS. 44A to 44C are illustrative diagrams of the agitating operation. As shown in FIG. 38, in the present embodiment, the mounting posture of the container support unit 24 is inclined. In FIGS. 44A to 44C, the direction parallel to the inclination angle direction of this mounting posture is defined as the Y′ direction. In the following description, the outlet member 201 side of the container 200 may be referred to as the −Y′ direction, and the opposite side as the +Y′ direction. Note that the arrows in FIGS. 44A to 44C indicate the direction of the flow of liquid occurring inside the bag 202 of the container 200.

In the present embodiment, the agitating operation is made up of a pressing operation and a pressure releasing operation. The pressing portion 61 is disposed so as to face the placement surface 41 of the container support unit 24. The pressing portion 61 is reciprocated between the pressure-releasing position and the pressure-applying position. This causes the bag 202 to deform, thereby causing the liquid inside to flow and be agitated.

FIG. 44A shows the pressing portion 61 (and the pressing member 60) in the pressure-releasing position. In the case of the present embodiment, at the pressure-releasing position, the pressing portion 61 is separated from the placement surface 41 and is located at a height where it does not come into contact with the bag 202, and does not press the bag 202. Therefore, the pressure-releasing position can also be called the non-pressing position.

From the state shown in FIG. 44A, the moving mechanism 63 is driven to perform the pressing operation as shown in FIG. 44B. In the pressing operation, the pressing member 60 rotates to move the pressing portion 61 to a position closer toward the placement surface 41 from the pressure-releasing position, and presses the bag 202 toward the placement surface 41. This causes the bag 202 to deform, thereby causing the liquid therein to flow and be agitated.

In the present embodiment, the container 200 is mounted to the storage portion 23A in an inclined posture with the outlet member 201 inclined downward in the Z direction. For this reason, at the stage shown in FIG. 44A, the liquid in the container 200 tends to be distributed unevenly toward the outlet member 201 due to its weight, and the bag 202 bulges more on the outlet member 201 side than in the center in the Y′ direction. Out of the end portions 42 and 43 of the container 200, the pressing portion 61 is designed to press against the end portion 43, where the outlet member 201 is provided. Since the pressing portion 61 presses the bulging portion of the bag 202 or a portion close to the bulging portion, the flow of the liquid in the bag 202 can be promoted.

Since the pressing portion 61 presses the side of the bag 202 closer to the outlet member 201, when the liquid flows to the opposite side, agitating can be effectively performed. The rotation shafts 62 of the pressing member 60 are located on the side opposite to the outlet member 201 as viewed from the pressing portion 61 in the Y′ direction of the container 200. In the pressing operation, the rotation direction of the pressing member 60 is clockwise in FIG. 44B. By setting the rotation direction in this way, a vector pointing in the +Y′ direction is generated, making it easier for the liquid to flow in the +Y′ direction. In other words, the liquid tends to flow toward the side of the bag 202 opposite to the outlet member 201 side.

As described above, in the present embodiment, out of the end portion 42 and end portion 43 of the container 200, the pressing portion 61 is designed to press the end portion 43 side where the outlet member 201 is provided. The bag 202 is pressed in the vicinity of the intake port 203 of the container 200, and the agitation of the fluid in the vicinity of this area is particularly promoted. During recording, the liquid in the container 200 flows out from the region close to the intake port 203 into the tube 51. By pressing the vicinity of the intake port 203 and agitating the liquid, it is possible to send liquid with a more uniform concentration into the tube 51.

From the state shown in FIG. 44B, the moving mechanism 63 is driven to perform the pressure releasing operation as shown in FIG. 44C. In the pressure releasing operation, the pressing member 60 rotates to return the pressing portion 61 from the pressure-applying position to the pressure-releasing position. When the pressure is released, the liquid in the bag 202 flows and the bag 202 attempts to return to its original shape. Thereafter, the pressing operation can be performed again.

By repeating the pressing operation and the pressure releasing operation, the liquid in the bag 202 is agitated. In other words, when the pressing portion 61 is at the pressure-applying position as shown in FIG. 44B, the vicinity of the pressing portion 61 of the container 200 is depressed, liquid flows in the +Y′ direction, and the side of the container 200 opposite the outlet member 201 bulges. Thereafter, when the pressure is released as shown in FIG. 44C, the ink that flowed due to the pressure flows in the −Y′ direction due to its own weight. By repeating the pressing operation and the pressure releasing operation, the liquid in the bag 202 moves back and forth in the Y′ direction and is agitated. The flow of the liquid caused by the pressure releasing operation utilizes the weight of the liquid. Utilizing the weight of the liquid makes it possible to simplify the mechanism required for agitating the liquid.

When the agitating operation is repeated, the agitating performance of the liquid can be adjusted by changing the period. During the pressure releasing operation, the flow of the liquid in the bag 202 is slightly delayed after the rotation of the pressing member 60. The higher the fluidity of the liquid during the pressure releasing operation is, the greater the agitating effect is. Furthermore, when the pressing operation is performed after the liquid has sufficiently flowed, the amount of liquid contained in the bag 202 in the vicinity of the pressing portion 61 increases, thereby causing bag 202 to bulge, and pressing this region further improves the agitating performance. The period of the agitating operation is, for example, slower than several Hz, and in particular, slower than 1 Hz. If the period of the agitating operation is too slow, the total agitation time may increase, increasing the amount of power consumed by the motor 635. Thus, the period of the agitating operation may be, for example, in the range of 0.5 to 0.7 Hz, particularly 0.6 Hz.

Furthermore, when the remaining amount decreases and the container 200 decreases in volume, the ink on the upper side (+Y′ side) of the inclined container 200 flows to the −Y′ side due to its own weight, and the amount of ink contained in this portion decreases. On the other hand, the liquid accumulates on the lower side (−Y′ side). In this state, the distance that the liquid flows in the +Y′ direction during the pressing operation is short, and the time it takes for the liquid to return during the pressure releasing operation is also short. Therefore, the period of the agitating operation may be shortened as the remaining amount of liquid in the container 200 decreases.

In the agitating operation, the pressing operation and the pressure releasing operation may be repeated with a time interval between one pressure releasing operation and the next pressing operation. After the pressure releasing operation, sufficient time can be provided for the liquid to flow within the bag 202 before the next pressing operation is started, and the flow of the liquid due to its own weight can be further promoted.

There are several methods for adjusting the period of the agitating operation. The first method utilizes the dwell angle, which is a range within which the cam follower 637 in contact with the inner cam surface 633e or the outer cam surface 633d is not displaced even when the cam 633 rotates. For example, the dwell angle at the position at which the cam follower 637 is at the highest point is set to 40 degrees, and the dwell angle at the lowest point is also set to 40 degrees. In particular, by ensuring a dwell angle of 40 degrees at the highest point, the pressure-releasing position can be maintained.

Also, the index angle, which is the angle range for raising or lowering the cam follower 637, may be set large, such as 140 degrees. This reduces the load on the cam 633 when it rotates, and also slowly transitions the connected pressing member 60 from the pressing state to the pressure-releasing position, thereby ensuring time for the ink to move to the vicinity of the pressing portion 61. This allows the ink to move sufficiently when pressure is released, thereby enhancing the agitating effect.

Another method is to temporarily stop the motor 635 at the pressure-releasing position. If the motor is stopped for a time period equivalent to the dwell angle of 40 degrees, the dwell angle can be made smaller, and the index angle can be made larger, thereby further reducing the load when the cam rotates.

The agitating operation may be performed at any time, such as during the supply of liquid to the liquid ejection apparatus 1, during the recovery operation performed on the ejection head 8 in the liquid ejection apparatus 1, or during standby for a recording operation. The timing of the agitating operation is basically not influenced by the operations of the liquid storage devices 40A and 40B or the liquid ejection apparatus 1.

The agitating time period during which the agitating operation is repeatedly performed may be based on time or the number of operations. For example, the agitating operation may be performed one course per day, with one course lasting several tens of minutes. As another example, the agitating operation may be performed one course per day, with one course including several tens of repetitions. The required agitating time period and execution timing may be set taking into consideration the settling rate of the coloring material in the liquid.

As described above with reference to FIG. 38, the containers 200 and the container support units 24 are mounted in the storage portion 23A and are inclined with respect to the horizontal plane in the mounted state. In terms of the effect of agitating the liquid, it is advantageous for the inclination angle to be less than 45 degrees, and more advantageously, to be 10 degrees or less. In the example of FIG. 38, the inclination angle is assumed to be 3 degrees.

Although agitating by pressure is possible even if the inclination angle is closer to 90 degrees, the weight of the ink acts in a direction that resists the liquid flow generated by pressing. Therefore, a stronger pressing force is required to cause the liquid to flow sufficiently. When the inclination angle is less than 45 degrees, the vector of liquid flow toward the −Y direction becomes relatively smaller due to the weight of the liquid. Regarding the amount of bulging of the −Y side portion of the bag 202 during the pressing operation, if the inclination angle is 10 degrees or less, a larger amount of bulging can be obtained with a smaller pressing force. If the bag 202 expands more when pressed, the amount of liquid flowing inside is greater. In other words, the pressing efficiency is good.

Note that in the present embodiment, the pressing portion 61 is located at a height where it does not come into contact with the bag 202 in the pressure-releasing position, but it may be in contact with the bag 202, and may be at a position at which the pressing portion 61 presses the bag 202 with a smaller amount of pressure than at the pressure-applying position. In this way, if the pressing member 60 is in a small pressing state at the pressure-releasing position, the upper limit position in the Z direction of the pressing member 60 can be kept low, and the size of the liquid storage devices 40A and 40B in the Z direction can be reduced.

Also, in the present embodiment, the pressing member 60 is provided on the case 230 of the storage portion 23A, but the pressing member 60 may be provided on the container support unit 24. In this case, when the container support unit 24 is mounted to the storage portion 23A, a configuration that enables drive transmission between the moving mechanism 63 and the pressing member 60 may be added.

Also, in the present embodiment, the container 200 is pressed by the pressing portion 61, but for example, the container 200 may be deformed by repeatedly blowing and stopping compressed air. Moreover, the space around the container 200 may be pressurized or depressurized to deform the container 200.

Also, in the present embodiment, it has been described that in the first agitation for ink whose colorant has a relatively fast settling rate, the ink is agitated by movement that deforms the container 200, and in the second agitation for ink whose colorant has a relatively fast settling rate, the ink is agitated by large movement that changes the posture of the container 200 and exchanges the ink up and down.

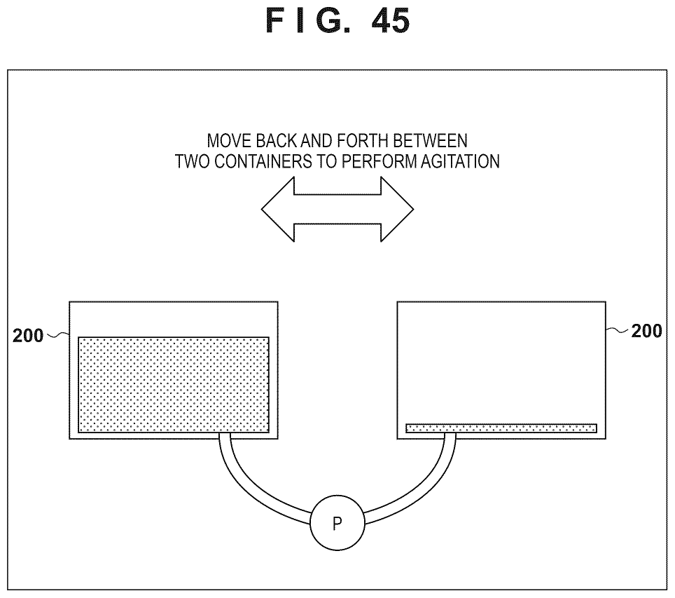

However, the present invention is not limited to these methods. For example, as shown in FIG. 45, two containers 200 may be connected by a tube, and in both the first agitation and the second agitation, the ink may be moved back and forth between the two containers by a pump P to perform agitation.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-072926, filed Apr. 26, 2024, which is hereby incorporated by reference herein in its entirety.

What is claimed is:

1. A liquid agitating apparatus comprising:
a first storing container configured to store a first liquid;
a first agitating mechanism configured to agitate the first liquid in the first storing container by causing the first storing container to undergo a first movement;
a second storing container configured to store a second liquid different from the first liquid; and
a second agitating mechanism configured to agitate the second liquid in the second storing container by causing the second storing container to undergo a second movement different from the first movement.

2. The liquid agitating apparatus according to claim 1,
wherein the first liquid is a liquid containing particles of a coloring material, and
the second liquid is a liquid containing particles having a larger particle size and a higher specific gravity than the first liquid.

3. The liquid agitating apparatus according to claim 1,
wherein the first liquid and the second liquid are each an ink containing a pigment.

4. The liquid agitating apparatus according to claim 1,
wherein the second liquid is a white ink.

5. The liquid agitating apparatus according to claim 4,
wherein the white ink contains titanium oxide.

6. The liquid agitating apparatus according to claim 1,
wherein the second liquid is a liquid containing a metal powder.

7. The liquid agitating apparatus according to claim 1,
wherein the first agitating mechanism causes the first storing container to undergo, as the first movement, movement for deforming the first storing container without positionally moving the first storing container.

8. The liquid agitating apparatus according to claim 1,
wherein the second agitating mechanism causes the second storing container to undergo, as the second movement, movement for changing a posture of the second storing container and positionally moving the second storing container.

9. The liquid agitating apparatus according to claim 8,
wherein the second agitating mechanism causes the second storing container to undergo, as the second movement, movement for rotating the second storing container.

10. The liquid agitating apparatus according to claim 1,
wherein at least one of the first agitating mechanism and the second agitating mechanism agitates the liquid by causing the liquid to move between a plurality of storing containers storing the liquid.

11. The liquid agitating apparatus according to claim 1,
wherein the first liquid and the second liquid are supplied to a liquid ejection apparatus including an ejection head that performs liquid ejection and a recovery device that recovers ejection performance of the ejection head, and
at least one of the first storing container and the second storing container is disposed one of under the recovery unit and under a region in which the ejection head performs scanning.

12. The liquid agitating apparatus according to claim 1,
wherein a plurality of the first storing container are disposed overlaid on each other in a plurality of levels.

13. The liquid agitating apparatus according to claim 1,
wherein the second storing container is disposed higher than the first storing container.
